(19) United States
(12) Patent Application Publication
(10) Pub. No.: US 2010/0097684 A1
(43) Pub. Date: Apr. 22, 2010

(54) DISPLAY ELEMENT

(75) Inventors: Kaori ONO, Tokyo (JP); Osamu ISHIGE, Kawasaki-shi (JP); Takeshi HAKII, Sagamihara-shi (JP); Akihito HISAMITSU, Sagamihara-shi (JP)

Correspondence Address: CANTOR COLBURN, LLP, 20 Church Street, 22nd Floor, Hartford, CT, 06103, US

(73) Assignee: KONICA MINOLTA HOLDINGS, INC., Tokyo (JP)

(21) Appl. No.: 12/581,456

(22) Filed: Oct. 19, 2009

(30) Foreign Application Priority Data
Oct. 22, 2008 (JP) 2008-271624
Aug. 7, 2009 (JP) 2009-184304

(51) Int. Cl. G02F 1/153

(52) U.S. Cl. 359/270; 359/273

(57) ABSTRACT

A display element containing at least 1 type of electrochromic compound, which is reversibly subjected to coloration or decoloration by at least either of electrochromic oxidation and reduction reaction, and an electrolyte between a pair of a display electrode and an opposed electrode; and undergoing a color tone change by an electrode driving operation, wherein a compound represented by following Formula (1) is held on the opposed electrode.

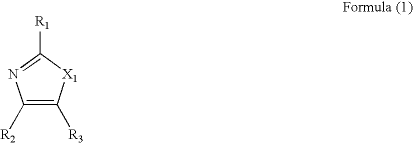

### TECHNICAL FIELD

The present invention relates to a newly developed electrochromic display element.

### BACKGROUND

Over recent years, with enhancement of operation speed of personal computers, widespread use of network infrastructure, and realization of mass storage of data, as well as cost reduction of data storage, there are increasing occasions in which information of documents and images, having been conventionally provided in the form of paper printed matter, is received and viewed as more convenient electronic information.

As viewing methods for these items of electronic information, there are mainly used those which are of light emitting types such as conventional liquid crystal displays and CRTs, or organic EL displays, which have recently been marketed. Especially, however, when electronic information is composed of pieces of document information, it is necessary to stare at these viewing devices for a relatively long period of time, which is certainly not viewer-friendly. It is commonly known that light emitting type displays have disadvantages such as eye fatigue due to flicker, inconvenience of portability, limited reading posture, necessity to look directly at still images, and high power consumption for long-time reading.

As display devices to overcome these disadvantages, there are known (memory-type) reflective displays, which employ external light, resulting in consuming no electrical power to retain images. However, these devices do not exhibit adequate performance due to the following reasons.

Namely, a system, employing a polarizing plate such as a reflective type liquid crystal, produces a problem in white display due to a low reflectance of about 40%, and most production methods of constituent members are neither simple nor easy. Further, polymer dispersion type liquid crystals require high operating voltage and exhibit poor contrast of resulting images due to the use of the refractive index difference between the used organic compounds. Still further, polymer network type liquid crystals have problems such that high operating voltage is required and complicated TFT circuits are needed to enhance memory capability. Yet further, display elements employing electrophoresis require a high operating voltage of at least 10 V and tend to exhibit low operation life due to electrophoretic particle aggregation.

As display Systems to overcome the disadvantages of each method described above, there are known electrochromic display elements (hereinafter referred to as EC systems) and electrodeposition systems (hereinafter referred to as ED systems) utilizing dissolution and deposition of a metal or a metal salt. Such EC systems have the advantages that full-color display can be realized at a low voltage of at most 3V; cell structures are simple; and white color quality is excellent. In ED systems, there are also advantages such that driving can be realized at a low voltage of at most 3V; cell structures are simple; and black and white contrast is excellent, as well as black color quality. A wide variety of methods have been disclosed, as described, for example, in WO 04/68231 pamphlet, WO 04/67673 pamphlet, U.S. Pat. No. 4,240,716 specification, Japanese Patent Publication No. 3428603, and Unexamined Japanese Patent Application Publication No. 2003-241227.

The present inventors conducted detailed investigations on the technology disclosed in each of these patent documents, and thereby found that any of the conventional technologies produced the problem of reflectance stability during repetitive driving. As a method to solve this problem, a method of adding a ferrocene compound, as a redox buffer, to an electrolyte is cited, for example, in Japanese Translation of PCT International Application Publication No. 2007-508587. However, it was found that further improvements were required to meet higher specifications demanded by users in recent years.

### DISCLOSURE OF THE INVENTION

### Problems to be Solved by the Invention

In view of the above problems, the present invention was completed. An object of the present invention is to provide a display element with a simple member structure being drivable at low voltage which is a display element exhibiting enhanced display contrast and white display reflectance, as well as exhibiting minimal variation in reflectance during repetitive driving.

### Means to Solve the Problems

The above object of the present invention can be achieved by the following constitution:

1. In a display element wherein at least 1 type of electrochromic compound, which is reversibly subjected to coloration or decoloration by at least either of electrochromic oxidation and reduction reaction, and an electrolyte are contained between a pair of a display electrode and an opposed electrode and a color tone change is carried out by an electrode driving operation, a display element holding a compound represented by following Formula (1) on the opposed electrode.

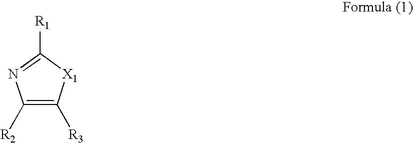

In Formula (1), R₁ represents a substituent; R₂ and R₃ each represent a hydrogen atom or a substituent; X₁ represents —N(R₄)—, —S—, or —O—; and R₄ represents a hydrogen atom or a substituent.

2. The display element described in item 1, wherein a compound represented by Formula (1) is chemically bonded to an opposed electrode via a silyl group.

3. The display element described in item 1, wherein a white scattering material is contained between a pair of the display electrode and the opposed electrode and substantial white display and colored display other than white are carried out by an electrode driving operation.

4. The display element described in item 1, wherein a metal salt compound, which can be dissolved and deposited by an electrode driving operation, is contained as an electrochromic compound in the electrolyte and black display and white display are carried out by the electrode driving operation.

5. The display element described in item 4, wherein the metal salt compound is a silver salt compound.

6. The display element described in item 1, wherein a compound represented by Formula (1) is contained as the electrochromic compound.

7. The display element described in item 6, wherein an electrochromic compound represented by Formula (1) is chemically bonded to the display electrode surface via a silyl group.

8. The display element described in item 1, wherein a promoter is contained in the electrolyte.

9. The display element described in item 8, wherein the promoter is an N-oxyl derivative, an N-hydroxyphthalimide derivative, a hydroxamic acid derivative, or a metallocene derivative.

10. The display element described in item 1, wherein the opposed electrode is a porous metal oxide electrode.

11. The display element described in item 10, wherein the porous metal oxide electrode is formed of a metal oxide fine particle.

12. The display element described in item 11, wherein the metal oxide fine particle is composed of ITO or titanium oxide.

13. The display element described in item 1, wherein the electrolyte contains at least 1 type of compound represented by following Formula (G1) or Formula (G2).

Rg₁₁-S-Rg₁₂ Formula (G1)

wherein Rg₁₁ and Rg₁₂ each represent a substituted or unsubstituted hydrocarbon group; the hydrocarbon group may contain at least one atom selected from a nitrogen atom, an oxygen atom, a phosphor atom, a sulfur atom, and a halogen atom; and Rg₁₁ and Rg₁₂ each may join to form a ring structure.

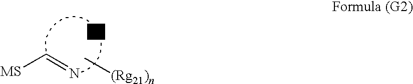

wherein M represents a hydrogen atom, a metal atom, or a quaternary ammonium; Z represents an atomic group needed to constitute a nitrogen-containing heterocyclic ring; n represents an integer of 0-5; and Rg₂₁ represents a substituent and when n is 2 or more, Rg₂₁'s each may be the same or differ or may join to form a condensed ring.

### EFFECTS OF THE INVENTION

According to the present invention, there was able to be provided a display element with a simple member structure being drivable at low voltage which is a display element exhibiting enhanced display contrast and white display reflectance, as well as exhibiting minimal variation in reflectance during repetitive driving.

### BRIEF DESCRIPTION OF THE DRAWING

FIG. 1 A schematic cross-sectional view showing one example of a constitution of the display element of the present invention.

### DESCRIPTION OF THE PREFERRED EMBODIMENT

In view of the above problems, the present inventors conducted diligent investigations and thereby found that using a display element holding a compound represented by above Formula (1) on an opposed electrode, there was able to be realized a display element with a simple member structure being drivable at low voltage which is a display element exhibiting enhanced display contrast and white display reflectance, as well as exhibiting minimal variation in reflectance during repetitive driving. Thus, the present invention was completed.

In the present invention, black display refers to a state of being black where a metal salt compound is reduced and then the metal is deposited. White display refers to a state where a metal salt compound is dissolved with no deposited metal, resulting in being colorless and a white scattering material produces white color. And colored display refers to a state where an electrochromic compound is reduced and a certain color is produced by the resulting reduced substance.

The present invention will now be detailed.

(Fundamental Structure of a Display Element)

In the display element of the present invention, a pair of a display electrode and an opposed electrode are arranged. For the display electrode, a transparent electrode such as an ITO electrode is provided and in contrast, a conductive electrode is provided for the opposed electrode as the other one. A compound represented by above Formula (1) according to the present invention is held on the opposed electrode. Between the display electrode and the opposed electrode, an electrochromic compound and an electrolyte are held, and more preferably, a metal salt compound is held as the electrochromic compound.

Further, to hold an electrochromic compound represented by Formula (1), the compound may be contained in an electrolyte or immobilized on the display electrode surface. However, immobilization on the display electrode surface is preferable. A voltage of positive polarity and negative polarity is applied between the display electrode and the opposed electrode, whereby by use of electrochromic reaction of a metal salt compound or an electrochromic compound represented by Formula (1), various colored states can reversibly be changed.

Still further, color display and black and white display are preferably carried out by planar arrangement of display areas in which colored displays other than black produce hues substantially differing from one another. For a method of planar arrangement of display areas producing different hues, it is preferable to hold different types of electrochromic compounds in a metal oxide porous layer.

In cases in which full-color display is carried out in the display element of the present invention, there are listed a method of planar arrangement in which a pair of opposed electrodes are divided with dividing walls and electrolytic liquids exhibiting different colors (electrolytic liquids containing electrochromic compounds of different type) are encapsulated in each of the dividing walls; and a method of holding different electrochromic compounds in a metal oxide porous layer via separate coating with no dividing walls. As such a separate coating method, a printing method and an ink-jet method are cited.

To accelerate electrochromic reaction of electrochromic materials, an auxiliary compound (a promoter), which can be oxidized and reduced, may optionally be added.

(Promoters)

Any promoters can appropriately be selected based on the intended purpose with no specific limitation. Well-known EC compounds can be employed. In the case of the use as a redox mediator, any of the well-known mediators, described in Yuki Gosei Kagaku Kyokaishi (Journal of Synthetic Organic Chemistry, Japan), Vol. 43, No. 6 (“Denki Enerugi Wo Riyosuru Yuki Gosei” Tokushu-go (Special Issue “Organic Synthesis Utilizing Electrical Energy”)) (1985), can appropriately be selected and used, based on the characteristics of an electrochromic compound used as a display dye.

Preferable promoters usable for the present invention include, for example, the following compounds.

1) Compounds having an N—O bond represented by TEMPO such as N-oxyl derivatives, N-hydroxyphthalimide derivatives, or hydroxamic acid derivatives

2) Compounds having an allyloxy free radical in which a bulky substituent is introduced into the o-position such as a galvinoxyl free radical

3) Metallocene derivatives such as ferrocene

4) Benzyl (diphenylethanedione) derivatives

5) Tetrazolium salts/formazan derivatives

6) Azine compounds such as phenazine, phenothiazine, phenoxazine, or acridine

7) Pyridinium compounds such as viologen

In addition, as a promoter, usable are benzoquinone derivatives, hydrazyl free radical compounds such as verdazyl, thiazyl free radial compounds, hydrazone derivatives, phenylenediamine derivatives, triallylamine derivatives, tetrathiafulvalene derivatives, tetracyanoquinodimethane derivatives, or thianthrene derivatives.

In the display element of the present intention, the promoters in the categories of 1)-7) described above are preferable, but those in 1) and 3) are specifically preferable.

(Electrodes)

<Display Electrode>

In the display element of the present invention, the display electrode is preferably a transparent electrode.

Such a transparent electrode is not specifically limited, if being transparent and electrically conductive. Examples thereof include Indium Tin Oxide (ITO: indium tin oxide), Indium Zinc Oxide (IZO: indium zinc oxide), fluorine-doped tin oxide (FTO), indium oxide, zinc oxide, platinum, gold, silver, rhodium, copper, chromium, carbon, aluminum, silicon, amorphous silicon, and BSO (Bismuth Silicon Oxide).

To form the electrode in this manner, for example, it is only necessary to mask-deposit an ITO film onto a substrate via a sputtering method, or to carry out pattering via photolithography after an ITO film have been entirely formed. Surface resistance is preferably at most 100Ω/□, more preferably at most 10Ω/□. The thickness of the transparent electrode is not specifically limited, being, however, commonly 0.1-20 μm.

<Metal Oxide Porous Layer>

A metal oxide porous layer may be formed on the above transparent electrode to immobilize an electrochromic compound. To enlarge surface area, such a metal oxide porous layer has fine pores, which can hold an electrochromic compound, on the surface and in the interior.

The specific surface area of the metal oxide porous layer is preferably 1-5000 m²/g, more preferably 10-2500 m²/g. Herein, such a specific surface area refers to a BET specific surface area determined from the adsorbed amount of nitrogen gas. When the specific surface area is excessively small, the adsorbed amount of an electrochromic compound is unable to be increased, whereby the object of the present invention is unachievable in some cases.

A metal oxide porous layer can be formed, for example, in such a manner that a plural number of semiconductor fine particles composed of a metal oxide are bonded together or brought into contact with one another.

Semiconductor fine particles contained in the above metal oxide porous layer are not specifically limited and can appropriately be selected based on the intended purpose, including, for example, simple semiconductors, oxide semiconductors, compound semiconductors, organic semiconductors, composite oxide semiconductors, and mixtures thereof. Any of these may contain an impurity as a dopant. Incidentally, the form of such a semiconductor is not specifically limited and may be single-crystalline, polycrystalline, amorphous, or in a mixed form thereof.

As the above semiconductor fine particles, metal oxide semiconductor fine particles are preferable. Metal oxide semiconductors are metal oxides having properties of semiconductors, including, for example, TiO₂, SnO₂, Fe₂O₃, SrTiO₃, WO₃, ZnO, ZrO₂, Ta₂O₅, Nb₂O₅, V₂O₅, In₂O₃, CdO, MnO, CoO, TiSrO₃, KTiO₃, Cu₂O, sodium titanate, barium titanate, and potassium niobate.

The shape of the semiconductor fine particles is not specifically limited and can appropriately be selected based on the intended purpose. Any of the spherical, nanotube, rod, whisker shapes is employable. At least 2 types of fine particles differing in shape can be mixed. The average particle diameter of spherical particles, as described above, is preferably 0.1-1000 nm, more preferably 1-100 nm. Herein, at least 2 types of fine particles differing in particle diameter distribution may be mixed. Further, the aspect ratio of the rod-shaped particles is preferably 2-50000, more preferably 5-25000.

An electrode holding an electrochromic compound according to the present invention on an electrode via chemical or physical adsorption can preferably be used. Such an electrochromic compound can be utilized as a full-color display material, which exhibits reversiblity and has memory capability, via electrochemical repetition of coloration and decoloration of this electrochromic compound.

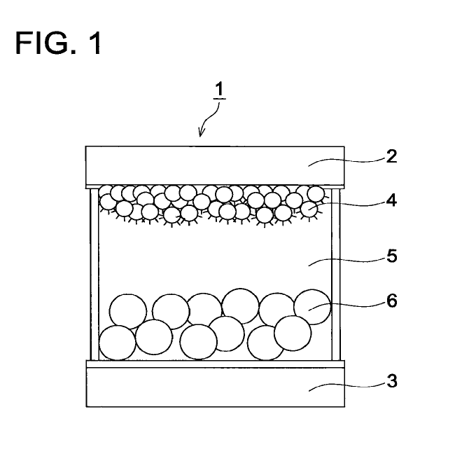

As a usage example, for example, as shown in FIG. 1, cited is display element 1 provided with display electrode 2, display layer 4, electrolyte 5, white scattering layer 6, and opposed electrode 3. In this display element, as the display layer, used is a layer wherein an electrochromic compound is allowed to react with a porous material composed of a metal oxide such as titanium oxide. A voltage of positive and negative polarities is applied between the electrodes to oxidize and reduce the electrochromic compound. And thereby, by use of the difference between the colored states of the oxidation and reduction states and of the white scattering layer arranged between the electrodes, colored display and white display can be carried out.

<Opposed Electrode>

In the display element of the present invention, as the opposed electrode, listed are a metal electrode, a carbon electrode, and a porous metal oxide electrode. In the present invention, from the viewpoint of affinity, contact properties, and adhesion properties of a compound represented by above Formula (1), a metal electrode and a porous metal oxide electrode are preferable, but the porous metal oxide electrode is most preferable.

As a metal electrode, usable are well-known metal species such as platinum, gold, silver, aluminum, zinc, nickel, titanium, bismuth, indium, tin, or alloys thereof. As a production method of such a metal electrode, existing methods such as a deposition method, a printing method, an ink-jet method, a spin coating method, or a CVD method are usable.

As metal oxide fine particles forming a porous metal oxide electrode, ITO and titanium oxide are preferable. The primary particle diameter thereof is preferably 10-100 nm, more preferably 10 nm—less than 80 nm. As a formation method of such a porous metal oxide electrode, there can be used any of the well-known formation methods such as a firing method (a fusion method) (polymer fine particles or inorganic particles are added to a binder and partially fused, and then pores having been generated among particles are utilized), an extraction method (a constituent layer is formed of an organic or inorganic substance soluble in a solvent and a binder insoluble in the solvent, and then the organic or inorganic substance is dissolved with the solvent to obtain fine pores), a foaming method in which a polymer is allowed to foam by heating or degassing, a phase conversion method in which a mixture of polymers is phase-separated via manipulation of a good solvent and a poor solvent, or a radiation irradiation method to form fine pores via irradiation of various kinds of radiations.

(A Compound Represented by Formula (1))

A compound represented by above Formula (1) according to the present invention functions as a reactive substance to the opposed electrode in the display element of the present invention and preferably exhibits heteropolar activity with respect to electrodeposion reaction and electrochromic reaction.

The compound represented by Formula (1) according to the present invention will now be described.

In Formula (1), R₁ represents a substituent; R₂ and R₃ each represent a hydrogen atom or a substituent; X₁ represents —N(R₄)—, —S—, or —O—; and R₄ represents a hydrogen atom or a substituent.

In Formula (1), specific examples of the substituents represented by R₁, R₂, and R₃ include, for example, an alkyl group (for example, a methyl group, an ethyl group, a propyl group, an isopropyl group, a t-butyl group, a pentyl group, and a hexyl group), a cycloalkyl group (for example, a cyclohexyl group and a cyclopentyl group), an alkenyl group, a cycloalkenyl group, an alkynyl group (for example, a propargyl group), a glycidyl group, an acrylate group, a methacrylate group, an aromatic group (for example, a phenyl group, a naphthyl group, and an anthracenyl group), a heterocyclic group (for example, a pyridyl group, a thiazolyl group, an oxazolyl group, an imidazolyl group, a furyl group, a pyrrolyl group, a pyrazinyl group, a pyrimidinyl group, a pyridazinyl group, a selenazolyl group, a sulfolanyl group, a piperidinyl group, a pyrazolyl group, and a tetrazolyl group), an alkoxy group (for example, a methoxy group, an ethoxy group, a propyloxy group, a pentyloxy group, a cyclopentyloxy group, a hexyloxy group, and a cyclohexyloxy group), an aryloxy group (for example, a phenoxy group), an alkoxylcarbonyl group (for example, a methyloxycarbonyl group, an ethyloxycarbonyl group, and a butyloxycarbonyl group), an aryloxycarbonyl group (for example, a phenyloxycarbonyl group), a sulfonamide group (for example, a methane sulfonamide group, an ethane sulfonamide group, a butane sulfonamide group, a hexane sulfonamide group, a cyclohexane sulfonamide group, and a benzene sulfonamide group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, a phenylaminosulfonyl group, and a 2-pyridylaminosulfonyl group), a urethane group (for example, a methylureide group, an ethylureide group, a pentylureide group, a cyclohexylureide group, a phenylureide group, and a 2-pyridylureide group), an acyl group (for example, an acetyl group, a propionyl group, a butanoyl group, a hexanoyl group, a cyclohexanoyl group, a benzoyl group, and a pyridinoyl group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, a phenylaminocarbonyl group, and a 2-pyridylaminocarbonyl group), an acylamino group (for example, an acetylamino group, a benzoylamino group, and a methylureide group), an amide group (for example, an acetamide group, a propionamide group, a butanamide, a hexanamide, and a benzamide group), a sulfonyl group (for example, a methylsulfonyl group, an ethylsulfonyl group, a butylsulfonyl group, a cyclohexylsulfonyl group a phenylsulfonyl group, and a 2-pyridylsulfonyl group), a sulfonamide (for example, a methylsulfonamide group, an octylsulfonamide group, a phenylsulfonamide group, and a naphthylsulfonamide group), an amino group (for example, an amino group, an ethylamino group, a dimethylamino group, a butylamino group, a cyclopentylamino group, an anilino group, and a 2-pyridylamino group), a halogen atom (for example, a chlorine atom, a bromine atom, and an iodine atom), a cyano group, a nitro group, a sulfa group, a carboxyl group, a hydroxyl group, a phosphono group (for example, a phosphonoethyl group, a phosphonopropyl group, and a phosphonooxyethyl group), and an oxamoyl group. These groups may further be substituted by any of these ones.

R₁ is preferably a substituted or unsubstituted aryl group, and is more preferably a substituted or unsubstituted phenyl group, most preferably a substituted or unsubstituted 2-hydroxyphenyl or 4-hydroxyphenyl group.

R₂ and R₂ are preferably an alkyl group, a cycloalkyl group, an aromatic group, or a heterocyclic group. It is more preferable that at least one of R₂ and R₃ be a phenyl group and the other be an alkyl group, but further more preferably, both of R₂ and R₃ are a phenyl group.

X₁ is preferably —N(R₄)—. R₄ is preferably a hydrogen atom, an alkyl group, an aromatic group, a heterocyclic group, or an acyl group, being, however, more preferably a hydrogen atom, an alkyl group having a carbon number of 1-10, an aryl group having a carbon number of 5-10, or an acyl group.

In the present invention, the compound represented by above Formula (1) may be a low-molecular substance or a polymer, provided that the compound contains a skeleton represented by Formula (1).

(Adsorption)

In the display element of the present invention, a compound represented by Formula (1) according to the present invention is held on an opposed electrode and it is preferable that the compound represented by Formula (1) be chemically or physically adsorbed on the opposed electrode. Chemical adsorption according to the present invention refers to a relatively strong adsorption state via chemical bonding to the electrode surface. And physical adsorption according to the present invention refers to a relatively weak adsorption state via van der Walls force acting between the electrode surface and an adsorbed substance.

In the present invention, chemical adsorption is specifically preferable. Adsorbed groups subjected to chemical adsorption include —CO₂H, —P═O(OH)₂, —OP═O(OH)₂, —SO₃H, and —Si(OR)₃ (R represents an alkyl group). Preferable are —CO₂H, —P═O(OH)₂, and —Si(OR)₃. Most preferable is —Si(OR)₃, provided that chemical bonding to the opposed electrode is formed via a silyl group.

Specific examples of the compound represented by Formula (1) will now be listed, but the present invention is not limited only to these exemplified compounds.

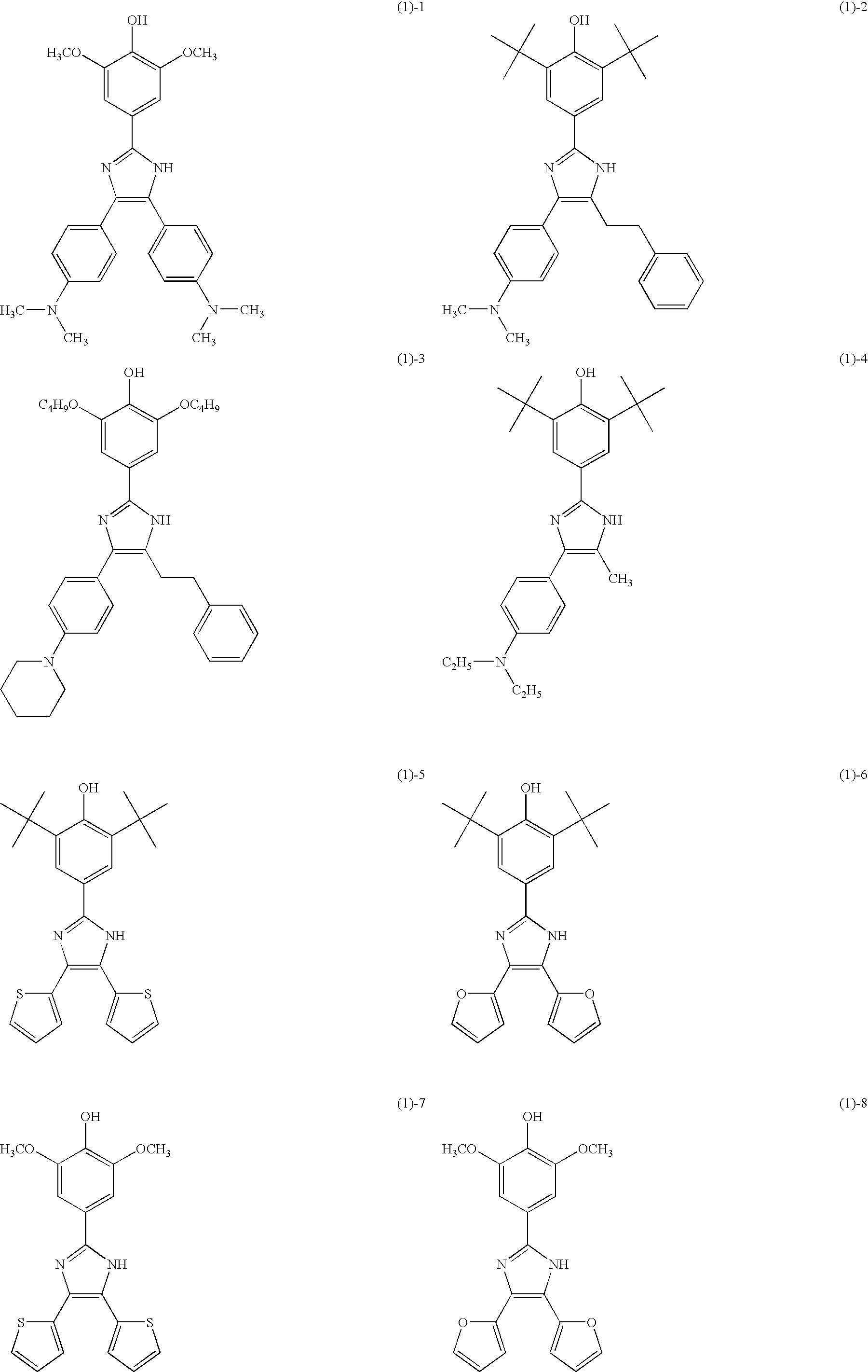

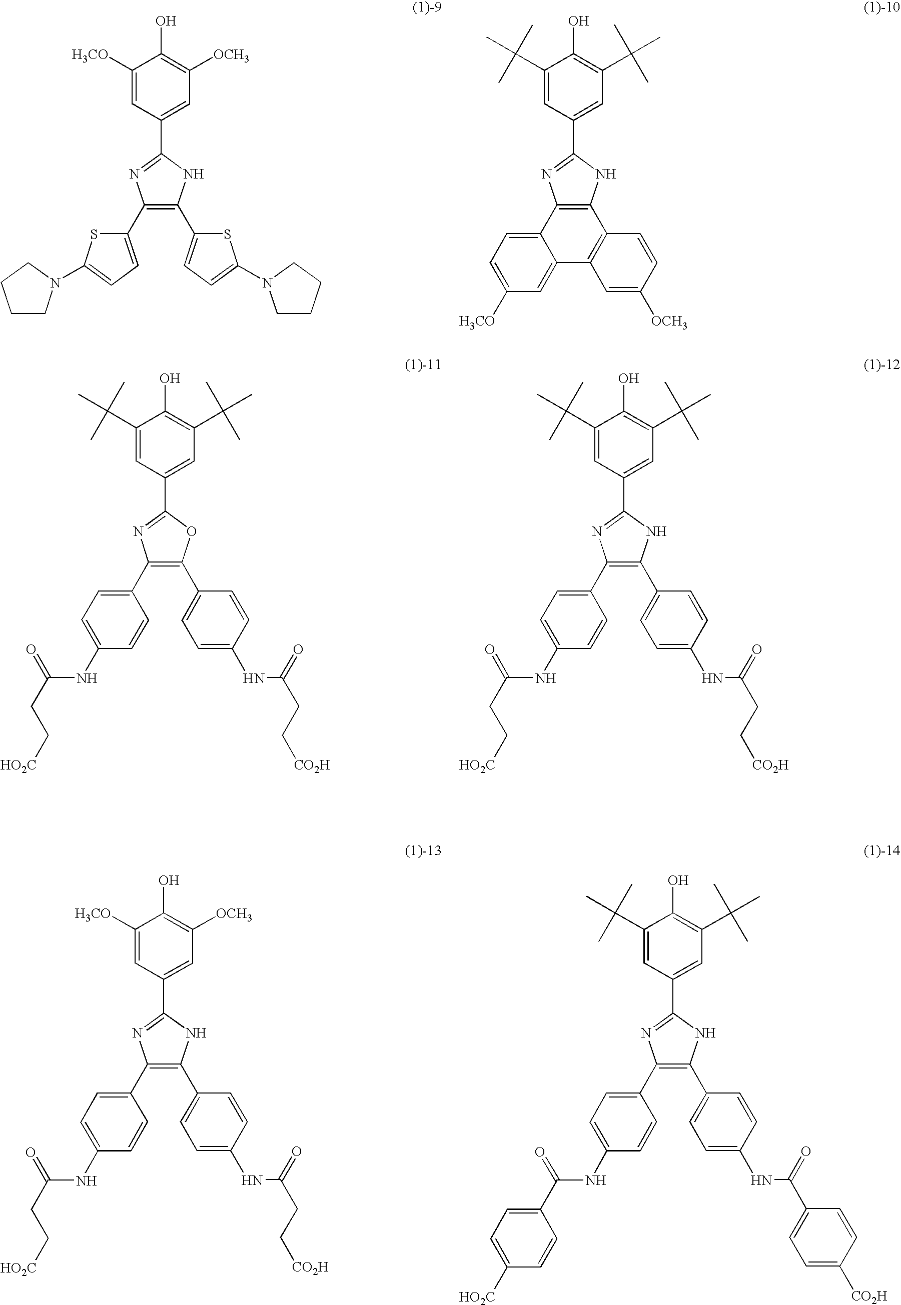

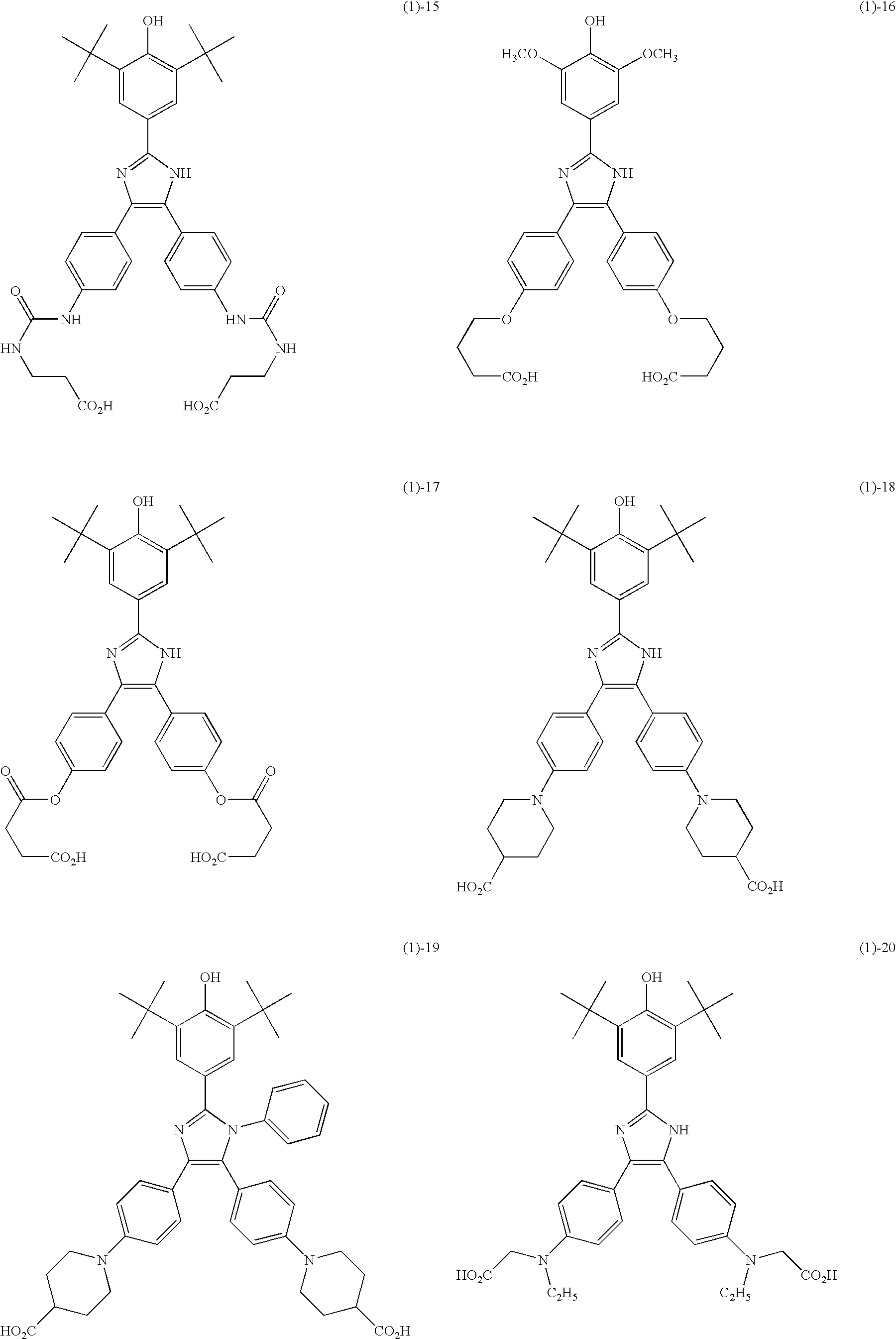

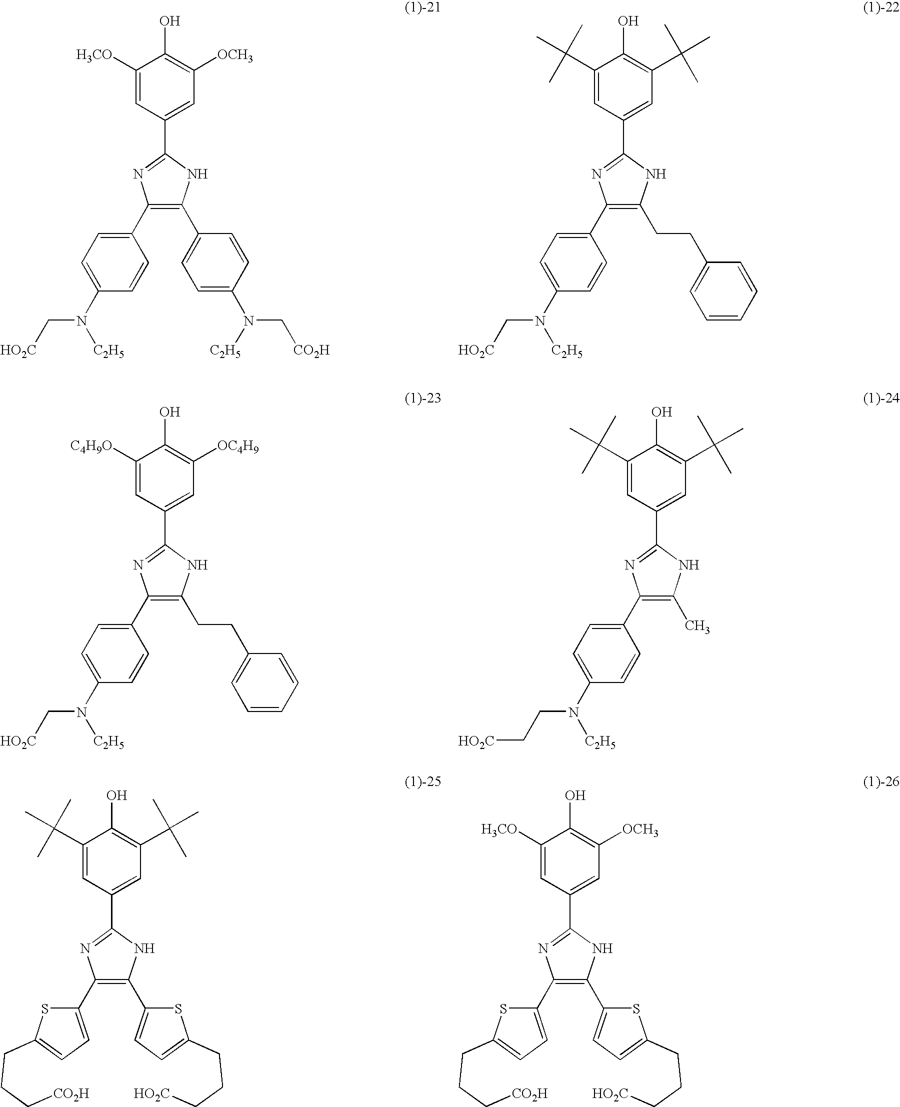

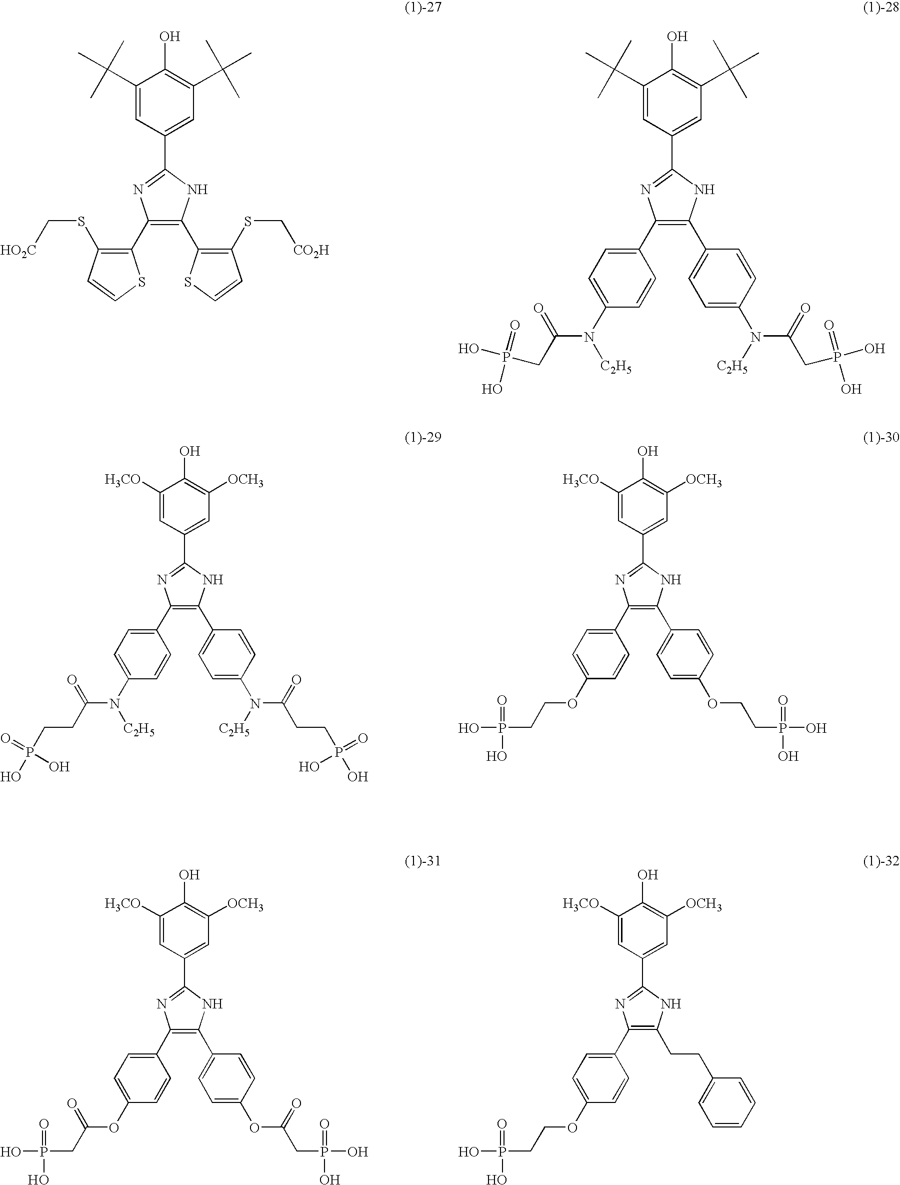

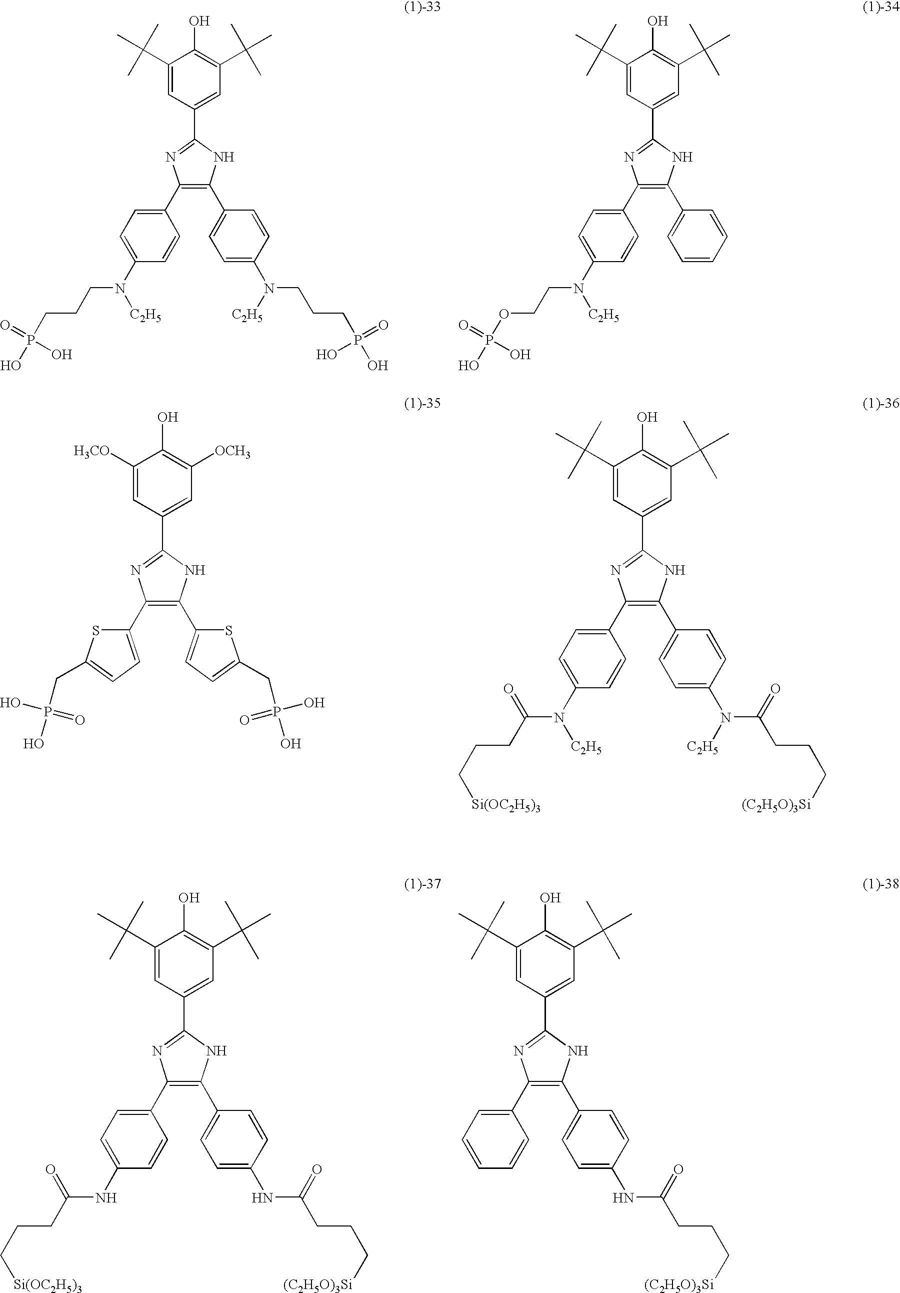

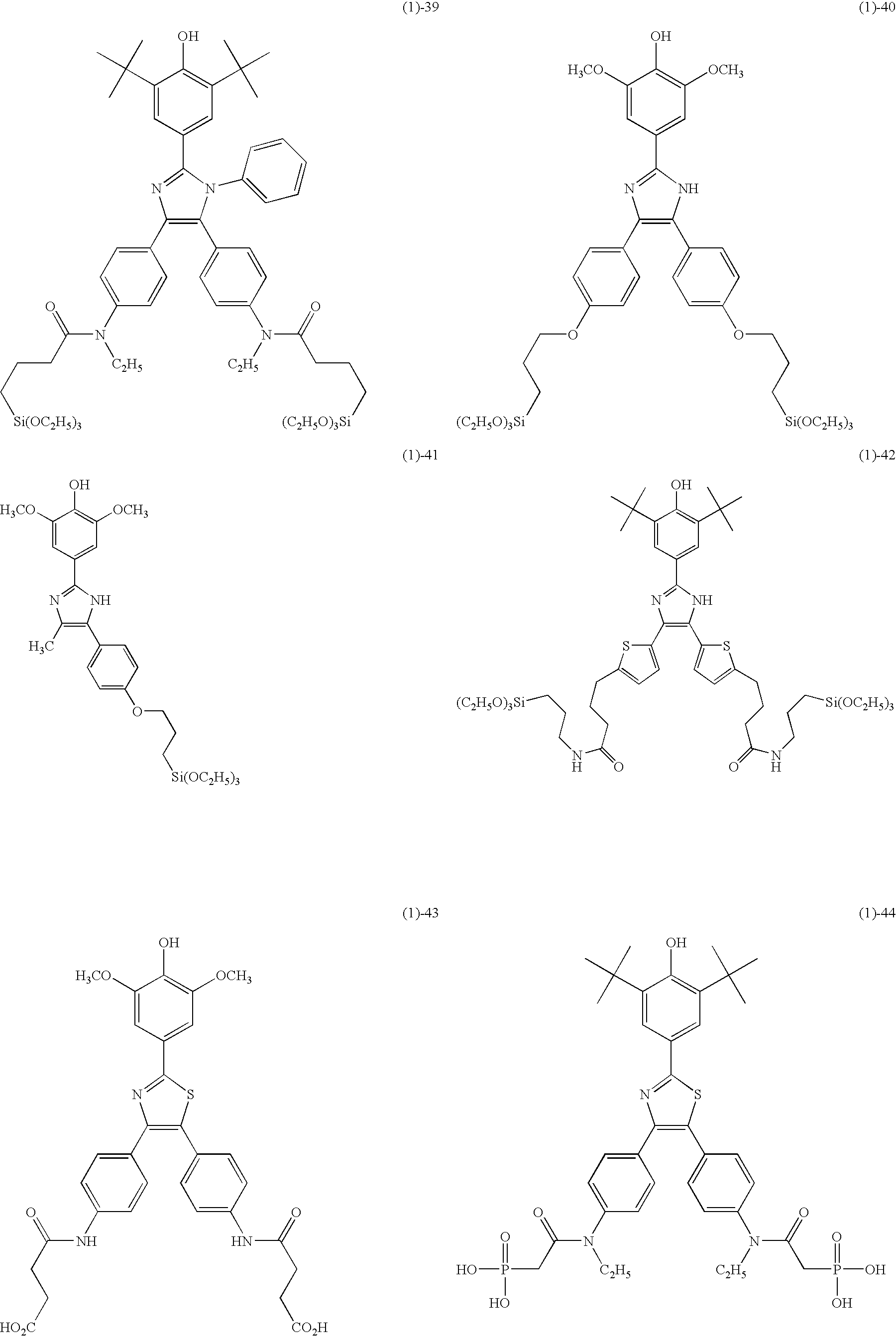

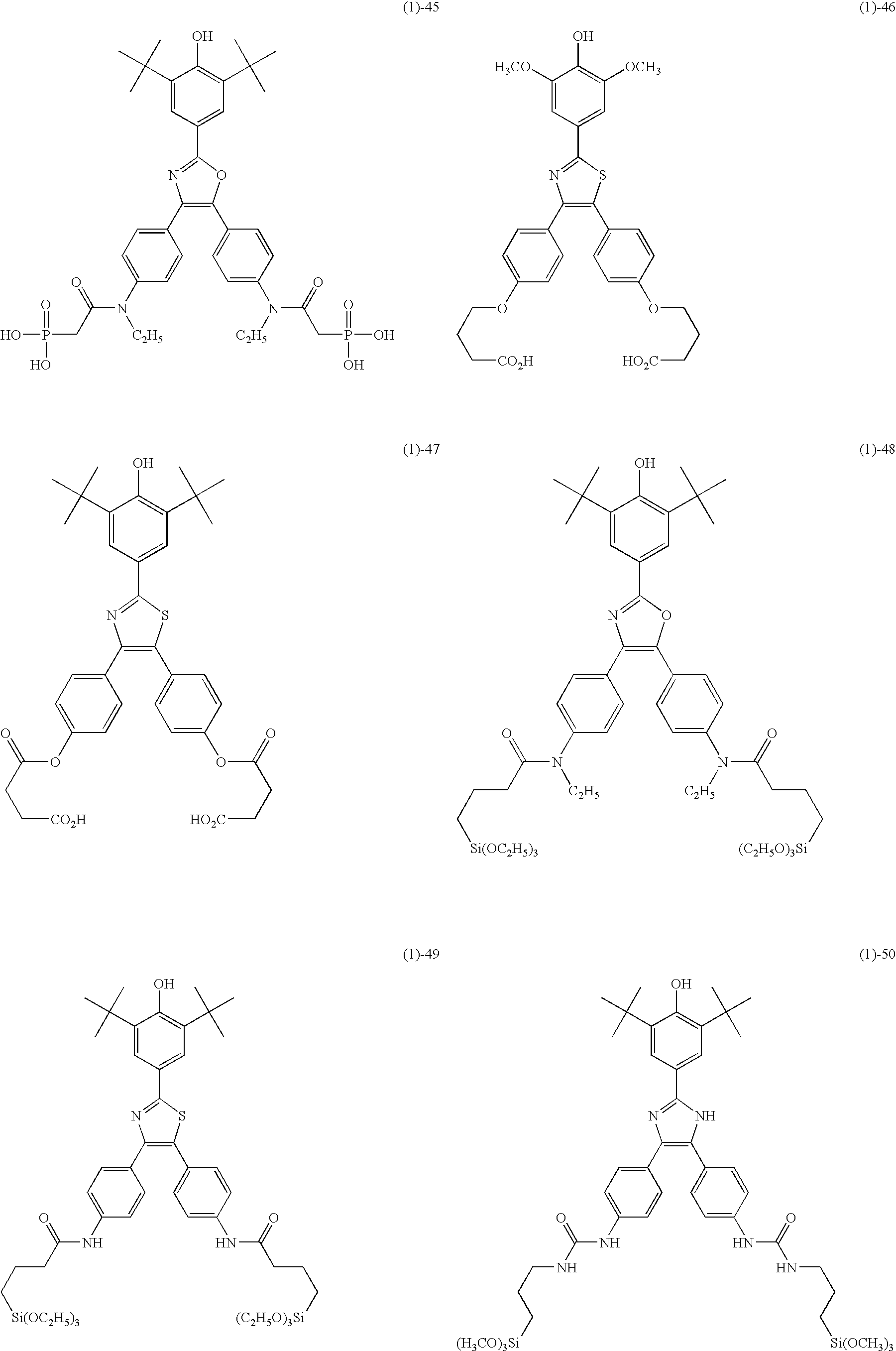

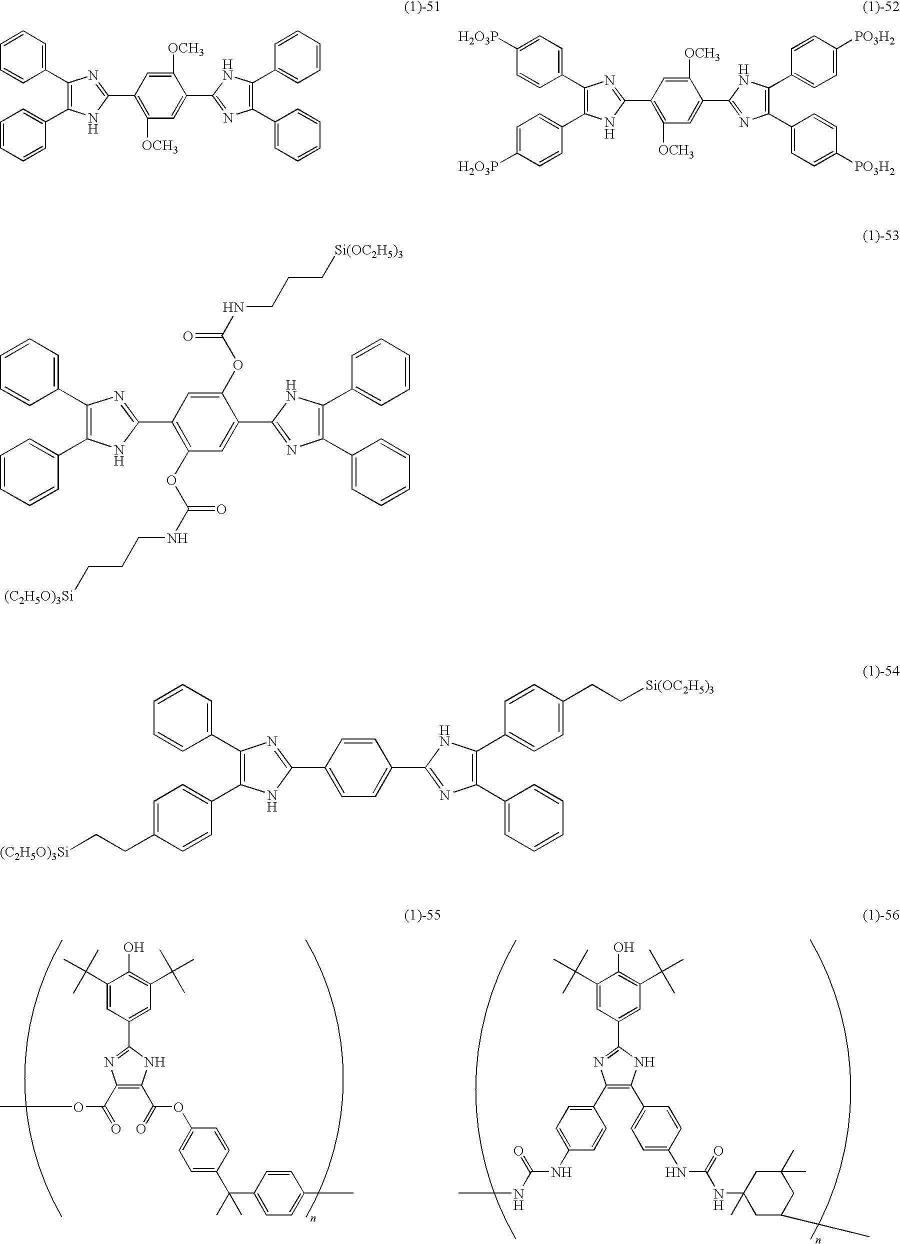

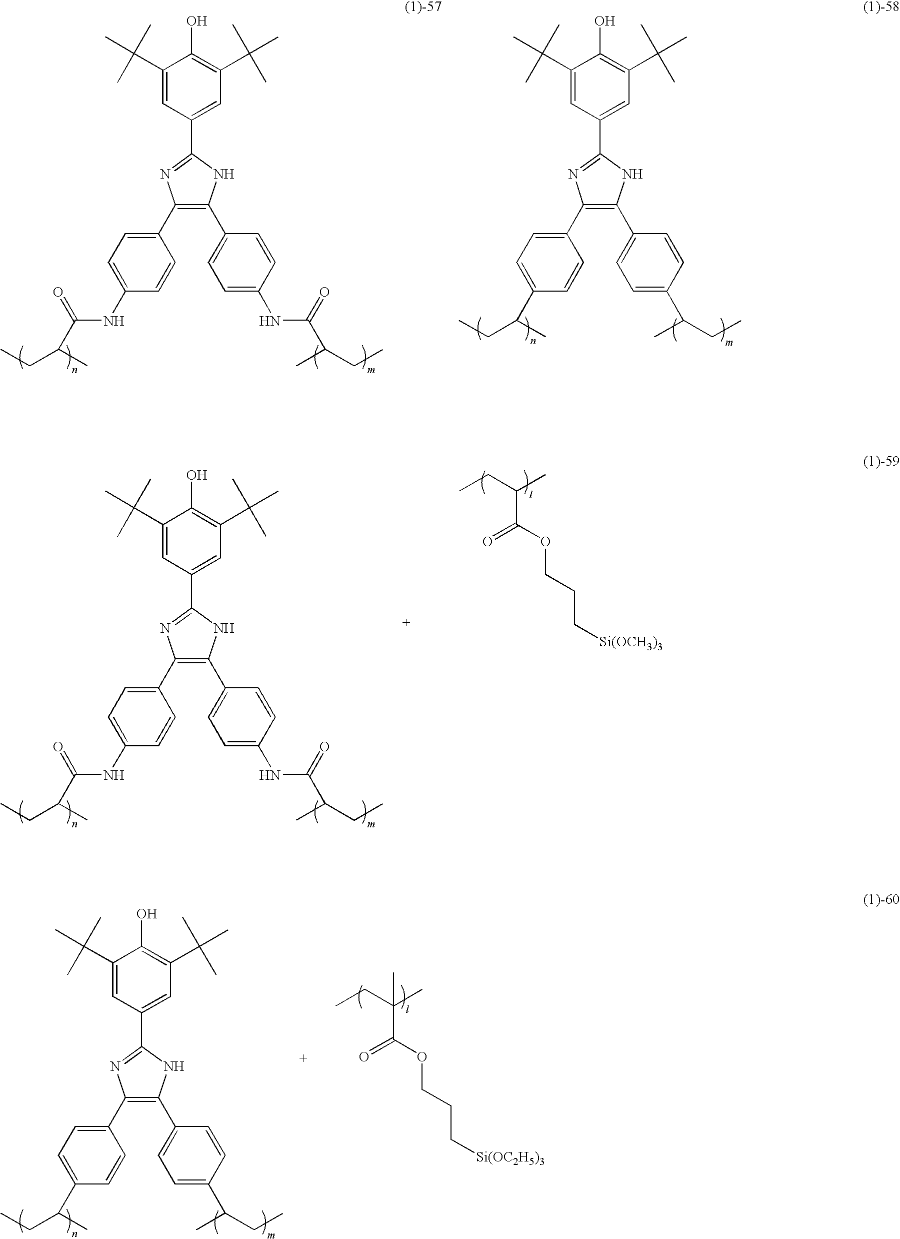

In the present invention, electrode reaction of a display element refers to reaction in which an active substance is electrochemically oxidized or reduced. The present invention is characterized in that a reaction product or a reactive substance on an opposed electrode is a compound represented by Formula (1), which is not limited to either such a reaction product or a reactive substance. The reactive substance in the present invention refers to a substance inducing chemical reaction. In contrast, the reaction product refers to a substance resulting from chemical reaction.

(Electrochromic Compounds)

In the present invention, at least 1 type of electrochromic compound, which is reversibly subjected to coloration or decoloration by at least either of electrochemical oxidation and reduction reaction, is contained between a pair of a display electrode and an opposed electrode. Such an electrochromic compound is not specifically limited, being preferably a metal salt compound, more preferably a silver salt compound.

Further, in the present invention, as an electrochromic compound, a compound represented by Formula (1) is also preferably contained. It is also one of the preferred embodiments that a metal salt compound and a compound represented by Formula (1) are contained at the same time.

(Metal Salt Compounds)

A metal salt compound according to the present invention may be any compound, provided that the above compound is a salt containing a metal species which can be dissolved and deposited by an electrode driving operation on at least one of the electrodes. A preferable metal species is silver, bismuth, copper, nickel, iron, chromium, or zinc. Of these, silver or bismuth is more preferable and silver is specifically preferable.

(Silver Salt Compounds)

A solver salt compound according to the present invention refers to a generic designation of silver and compounds containing silver in the chemical structure thereof, including, for example, silver oxide, silver sulfide, metal silver, silver colloidal particles, silver halides, silver complex compounds, compounds of silver ion. The phase state species such as a solid state, a solubilized state to liquid, or a gas state and the charge state species such as the neutral, anionic, or cationic state are not specifically taken into consideration.

The concentration of a metal ion contained in an electrolyte according to the present invention preferably satisfies the relationship: 0.2 mol/kg≦[Metal]≦2.0 mol/kg. When such a metal ion concentration is at least 0.2 mol/kg, a silver solution of adequate concentration is realized to achieve a desired driving rate. In the case of at most 2 mol/kg, deposition is prevented and the stability of an electrolytic liquid during low temperature storage is enhanced.

(Concentration Ratio of a Halogen Ion to a Metal Ion)

In the display element of the present invention, when the molar concentration of a halogen ion or a halogen atom contained in an electrolyte is [X] (mol/kg) and the total molar concentration of silver or silver in a compound containing the silver in its chemical structure contained in the above electrolyte is (Metal)] (mol/kg), the condition defined by following Expression (1) is preferably satisfied:

0≦[X]/(Metal)≦0.1 Expression (1)

The halogen atom referred to in the present invention refers to an iodine atom, a chlorine atom, a bromine atom, or a fluorine atom. When [X]/[Metal] is larger than 0.1, the reaction of X⁻→X₂ is induced during redox reaction of a metal and then the X₂ is readily subjected to cross-oxidation with the deposited metal, resulting in dissolution of the deposited metal, which produces one factor to decrease memory capability. Therefore, the molar concentration of a halogen atom is preferably as small as possible, compared to that of metal silver. In the present invention, the relationship of 0≦[X]/[Metal]≦0.001 is more preferable. When halogen ions are added, with regard to the halogen species, the total molar concentration of each of the halogen species preferably satisfies the relationship: [I]<[Br]<[Cl]<[F] from the viewpoint of memory capability enhancement.

(Adsorption to the Display Electrode)

In the display element of the present invention, a compound represented by Formula (1) according to the present invention is preferably chemically or physically adsorbed to the display electrode surface. In the present invention, chemical adsorption is specifically preferable. Adsorbed groups subjected to chemical adsorption include —CO₂H, —P═O(OH)₂, —OP═O(OH)₂, —SO₃H, and —Si(OR)₃ (R represents an alkyl group). Preferable are —CO₂H, —P═O(OH)₂, and —Si(OR)₃. Most preferable is —Si(OR)₃, provided that chemical bonding to the opposed electrode is formed via a silyl group.

(Electrolytes)

In the present invention, an electrolyte is contained between a pair of a display electrode and an opposed electrode. The “electrolyte” referred to in the present invention refers to a substance which is usually dissolved in a solvent such as water to produce a solution exhibiting ion conductivity (hereinafter referred to as a “narrowly-defined electrolyte”). In the description of the present invention, a mixture, prepared by incorporating another metal or compound, regardless of whether an electrolyte or a non-electrolyte, into a narrowly-defined electrode, is referred to as an electrolyte (a “broadly-defined electrode”).

(Electrolyte Solvents)

In the present invention, electrolyte solvents are not specifically limited, specifically including tetramethylurea, sulfolane, dimethyl sulfoxide, 1,3-dimethyl-2-imidazolidinone, 2-(N-methyl)-2-pyrrolidinone, hexamethylphosphortriamide, N-methylpropioneamide, N,N-dimethylacetamide, N-methylacetamide, N,N-dimethylformamide, N-methylformamide, butyronitrile, propionitrile, acetonitrile, acetylacetone, 4-methyl-2-pentanone, 2-butanol, 1-butanol, 2-propanol, 1-propanol, ethanol, methanol, acetic anhydride, ethyl acetate, ethyl propionate, dimethoxyethane, diethoxyfuran, tetrahydrofuran, ethylene glycol, diethylene glycol, triethylene glycol monobutyl ether, ethylene carbonate, propylene carbonate, dimethyl carbonate, diethyl carbonate, methylethyl carbonate, γ-butylolactone, dioxolane, sulfolane, diethyl ether, 1,2-dimethoxyethane, diethylene glycol dimethyl ether, 2-methyltetrahydrofuran, dioxane, methyldioxolaneacetonitrile, benzonitrile, nitrobenzene, N,N-dimethylformamide, N,N-diethylformamide, sulfoxide, dimethyl sulfoxide, dimethyl sulfone, tetramethylene sulfone, N-methyl-2-oxazolidinone, and water.

Of these solvents, at least 1 kind of solvent having a freezing point of at most −20° C. and a boiling point of at least 120° C. is preferably contained.

Further, solvents usable for the present invention include the compounds described in J. A. Riddick, W. B. Bunger, and T. K. Sakano, “Organic Solvents”, 4th ed., John Wiley & Sons (1986); Y. Marcus, “Ion Solvation”, John Wiley & Sons (1985); C. Reichardt, “Solvents and Solvent Effects in Chemistry”, 2nd ed., VCH (1988); and G. J. Janz and R. P. T. Tomkins, “Nonaqueous Electrolytes Handbook”, Vol. 1, Academic Press (1972).

Solvents specifically preferably used in the present invention are compounds represented by following Formulas (S1) and (S2).

(Compounds Represented by Formulas (S1) and (S2))

In the display element of the present invention, an electrolyte preferably contains a compound represented by following Formula (S1) or (S2).

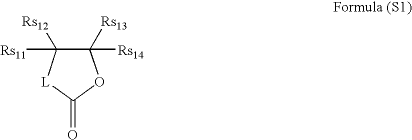

wherein L represents an oxygen atom or an alkylene group and R_{S11}-R_{S14} each represent a hydrogen atom, an alkyl group, an alkenyl group, an aryl group, a cycloalkyl group, an alkoxyalkyl group, or an alkoxy group.

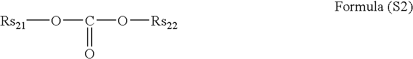

wherein R_{S21} and R_{S22} each represent an alkyl group, an alkenyl group, an aryl group, a cycloalkyl group, an alkoxyalkyl group, or an alkoxy group.

Initially, the compound represented by Formula (S1) will now be detailed.

In Formula (S1), L represents an oxygen atom or an alkylene group and R_{S11}-R_{S14} each represent a hydrogen atom, an alkyl group, an alkenyl group, an aryl group, a cycloalkyl group, an alkoxyalkyl group, or an alkoxy group. These substituents may further be substituted with any appropriate substituent.

The alkyl group includes, for example, a methyl group, an ethyl group, a propyl group, an isopropyl group, a t-butyl group, a pentyl group, a hexyl group, an octyl group, a dodecyl group, a tridecyl group, a tetradecyl group, and a pentadecyl group. The aryl group includes, for example, a phenyl group and a naphthyl group. The cycloalkyl group includes, for example, a cyclopentyl group and a cyclohexyl group. The alkoxyalkyl group includes, for example, a β-methoxyethyl group and a γ-methoxypropyl group. The alkoxy group includes, for example, a methoxy group, an ethoxy group, a propyloxy group, a pentyloxy group, a hexyloxy group, an octyloxy group, and a dodecyloxy group.

Specific examples of the compound represented by Formula (S1) will now be listed but the present invention is not limited only to these exemplified compounds.

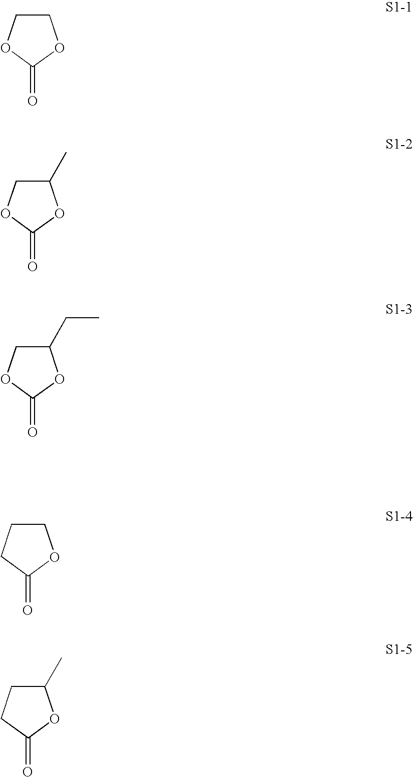

Next, the compound represented by Formula (S2) will now be detailed.

In Formula (S2), R_{S21} and R_{S22} each represent an alkyl group, an alkenyl group, an aryl group, a cycloalkyl group, an alkoxyalkyl group, or an alkoxy group.

The alkyl group includes, for example, a methyl group, an ethyl group, a propyl group, an isopropyl group, a t-butyl group, a pentyl group, a hexyl group, an octyl group, a dodecyl group, a tridecyl group, a tetradecyl group, and a pentadecyl group. The aryl group includes, for example, a phenyl group and a naphthyl group. The cycloalkyl group includes, for example, a cyclopentyl group and a cyclohexyl group. The alkoxyalkyl group includes, for example, a β-methoxyethyl group and a γ-methoxypropyl group. The alkoxy group includes, for example, a methoxy group, an ethoxy group, a propyloxy group, a pentyloxy group, a hexyloxy group, an octyloxy group, and a dodecyloxy group.

Specific examples of the compound represented by Formula (S2) will now be listed but the present invention is not limited only to these exemplified compounds.

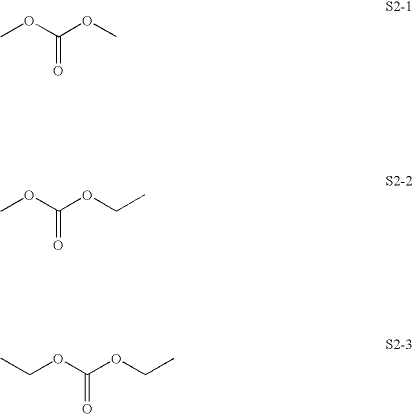

Of the exemplified compounds represented by Formulas (S1) and (S2), exemplified compounds S1-1, 51-2, and S2-3 are specifically preferable.

In the present invention, an electrolyte solvent may be either a single species or a solvent mixture, but a mixed solvent containing ethylene carbonate is preferable. The amount of ethylene carbonate added is preferably 101 by mass-90% by mass, based on the total electrolyte solvent mass. A specifically preferable electrolyte solvent is a mixed solvent of propylene carbonate/ethylene carbonate having a mass ratio of 7/3-3/7. When the propylene carbonate ratio is more than 7/3, ion conductivity is degraded, resulting in a decrease in response speed. In the case of less than 3/7, an electrolyte tends to be deposited at low temperatures.

Further, in the present invention, a solid electrolyte may be used as an electrolyte. As polymers used for such a solid electrolyte, there can be listed vinylidene fluoride polymers such as polyvinylidene fluoride, vinylidene fluoride-hexafluoropropylene copolymers, vinylidene fluoride-ethylene copolymers, vinylidene fluoride-monofluoroethylene copolymers, vinylidene fluoride-trifluoroethylene copolymers, vinylidene fluoride-tetrafluoroethylene copolymers, or vinylidene fluoride-hexafluoropropylene-tetrafluoroethylene ternary copolymers; and acrylonitrile polymers such as acrylonitrile-methyl methacrylate copolymers, acrylonitrile-methyl acrylate copolymers, acrylonitrile-ethyl methacrylate copolymers, acrylonitrile-ethyl acrylate copolymers, acrylonitrile-methacrylic acid copolymers, acrylonitrile-acrylic acid copolymers, or acrylonitrile-vinyl acetate copolymers, as well as polyethylene oxide, ethylene oxide-propylene oxide copolymers, and polymers of acrylates or methacrylates thereof.

Any of these polymers may be used alone as such. Those in a gel form prepared by incorporating an electrolytic liquid into these polymers or by adding a low molecular gelling agent to an electrolytic liquid may optionally be used.

<Supporting Electrolytes>

As a supporting electrolyte used in the present invention, a salt, an acid, or an alkali commonly employed in the field of electrochemistry or batteries can be used. The salt is not specifically limited. Usable are, for example, an inorganic ion salt such as an alkali metal salt or an alkaline-earth metal salt; a quaternary ammonium salt; a cyclic quaternary ammonium salt; and a quaternary phosphonium salt.

Specific examples of such salts include Li salts, Na salts, and K salts having a counter anion selected from halogen ions, SCN⁻, ClO₄⁻, BF₄⁻, CF₃SO₃⁻, (CF₃SO₂)₂N⁻, (C₂F₅SO₂)₂N⁻, PF₆⁻, AsF₆⁻, CH₃COO⁻, CH₃(C₆H₄)SO₃⁻, and (C₂F₅SO₂)₃C⁻.

Further, listed are quaternary ammonium salts having a counter anion selected from halogen ions, SCN⁻, ClO₄⁻, BF₄⁻, CF₃SO₃⁻, (CF₃SO₂)₂N⁻, (C₂F₅SO₂)₂N⁻, PF₆⁻, AsF₆⁻, CH₃COO⁻, CH₃(C₆H₄) SO₃⁻, and (C₂F₅SO₂)₃C⁻. Specifically, listed are (CH₃)₄NBF₄, (C₂H₅)₄NF₄, (n-C₄H₉)₄NBF₄, (C₂H₅)₄NBr, (C₂H₅)₄NClO₄, (n-C₄H₉)₄NClO₄, CH₃(C₂H₅)₃NBF₄, (CH₃)₂(C₂H₅)₂NBF₄, (CH₃)₄NSO₃CF₃, (C₂H₅)₄NSO₃CF₃, and (n-C₄H₉)₄NSO₃CF₃. Still further,

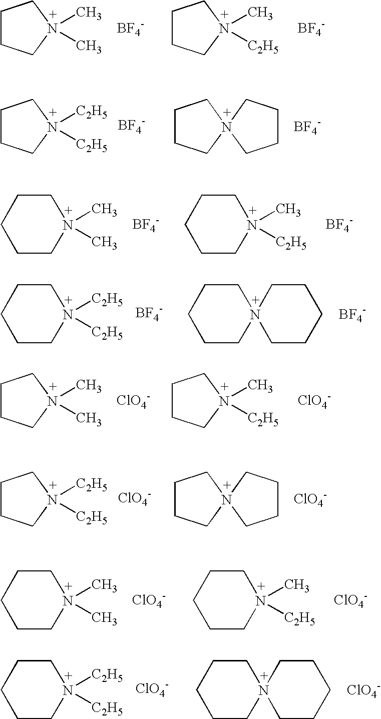

are listed.

And, listed are phosphonium salts having a counter anion selected from halogen ions, SCN⁻, ClO₄⁻, BF₄⁻, CF₃SO₃⁻, (CF₃SO₂)₂N⁻, (C₂F₅SO₂)₂N⁻, PF₆⁻, ASF₆⁻, CH₃COO⁻, CH₃ (C₆H₄)SO₃⁻, and (C₂F₅SO₂)₃C⁻, specifically (CH₃)₄PBF₄, (C₂H₅)₄PBF₄, (C₃H₇)₄PBF₄, and (C₄H₉)₄PBF₄. Mixtures thereof can also preferably be used.

As a supporting electrolyte according to the present invention, a quaternary ammonium salt is preferable and a quaternary spiroammonium salt is specifically preferable. Further, as a counter anion, ClO₄⁻, BF₄⁻, CF₃SO₃⁻, (C₂F₅SO₂)₂N⁻, and PF₆⁻ are preferable and BF₄⁻ is specifically preferable.

The amount of an electrolyte salt used can appropriately be determined. The electrolyte salt commonly exists at an upper limit of 20 M, preferably 10 M, more preferably 5 M. The lower limit is commonly 0.01 M, preferably 0.05 M, more preferably 0.1 M.

<White Scattering Materials>

In the present invention, from the viewpoint of enhancement of display contrast and white display reflectance, a white scattering material is preferably contained. A porous white scattering layer may be arranged via formation thereof.

A porous white scattering layer applicable to the present invention can be formed by coating and drying an aqueous mixture of an aqueous polymer, being substantially insoluble in an electrolyte solvent, and a white pigment.

Examples of the white pigment applicable to the present invention include, for example, titanium dioxide (anatase or rutile type), barium sulfate, calcium carbonate, aluminum oxide, zinc oxide, magnesium oxide, zinc hydroxide, magnesium hydroxide, magnesium phosphate, magnesium hydrogen phosphate, alkaline earth metal salts, talc, kaolin, zeolite, acid clay, glass, and organic compounds such as polyethylene, polystyrene, acrylic resins, ionomers, ethylene-vinyl acetate copolymeric resins, benzoguanamine resins, urea-formalin resins, melamine-formalin resins, or polyamide resins. These compounds may be used individually or in combination, and may also be used in a state where voids, capable of varying refractive index, are contained in particles.

In the present invention, of the above white particles, titanium dioxide, zinc oxide, and zinc hydroxide are preferably used. Further, usable are titanium dioxide surface-treated with an inorganic oxide (e.g., Al₂O₃, AlO(OH), or SiO₂); and titanium dioxide which is further treated, in addition to the above surface treatment, with an organic compound such as trimethylol ethane, triethanolamine acetate, or trimethylcyclosilane. Of these white particles, titanium oxide or zinc oxide is more preferably used from the viewpoint of coloring prevention at high temperatures and of the reflectance of an element resulting from the refractive index.

In the present invention, as aqueous polymers, which are substantially insoluble in an electrolyte solvent, water-soluble polymers and polymers dispersed in an aqueous solvent are listed.

Examples of such water-soluble polymers include protein such as gelatin or gelatin derivatives; cellulose derivatives; natural compounds such as polysaccharides including starch, gum arabic, dextran, pullulan, carageenan; and synthetic polymers such as polyvinyl alcohol, polyvinyl pyrrolidone, acrylamide polymers, or their derivatives. The gelatin derivatives include acetylated gelatin and phthalated gelatin. The polyvinyl alcohol derivatives include terminal alkyl-modified polyvinyl alcohol and terminal mercapto group-modified polyvinyl alcohol. The cellulose derivatives include hydroxyethyl cellulose, hydroxypropyl cellulose, and carboxymethyl cellulose. In addition, there are also usable those described in Research Disclosure and on pages 71-75 of Unexamined Japanese Patent Application Publication (hereinafter referred to as JP-A) No. 64-13546; and highly water-absorbing polymers described in U.S. Pat. No. 4,960,681 specification and JP-A No. 62-245260, namely including homopolymers of vinyl monomers containing —COOM or —SO₃ M (M is a hydrogen atom or an alkali metal) and copolymers of these monomers or of the same and other monomers (e.g., sodium methacrylate, ammonium methacrylate, and potassium acrylate). These binders can be used in combinations of at least 2 kinds.

In the present invention, gelatin, gelatin derivatives, polyvinyl alcohol, or their derivatives are preferably usable.

Examples of polymers dispersed in an aqueous solvent include latexes such as natural rubber latex, styrene butadiene rubber, butadiene rubber, nitrile rubber, chloroprene rubber, or isoprene rubber; and thermosetting resins prepared by dispersing, in an aqueous solvent, polyisocyanate based, epoxy based, acrylic based, silicone based, polyurethane based, urea based, phenol based, formaldehyde based, epoxy-polyamide based, melamine based, alkyd based, or vinyl based resins; Of these polymers, aqueous polyurethane resins described in JP-A No. 10-76621 are preferably used.

The meaning of “being substantially insoluble in an electrolyte solvent” referred to in the present invention is defined as a state in which the dissolved amount per kg of an electrolyte solvent is 0 g -10 g in the temperature range of −20° C.-120° C. Such a dissolved amount can be determined using any of the methods known in the art such as a mass measurement method or a component quantitative method employing a liquid chromatogram or a gas chromatogram.

In the present invention, an aqueous mixture of an aqueous compound and a white pigment is preferably in a form where the white pigment is dispersed in water using a well-known dispersion method. The mixture ratio of the aqueous compound/the white pigment is preferably 1-0.01 by volume, more preferably 0.3-0.05 by volume.

In the present invention, a medium to coat an aqueous mixture of an aqueous compound and a white pigment may be located anywhere if being located on a component between the opposed electrodes of a display element, but is preferably provided on the surface of at least one of the opposed electrodes. Examples of medium providing methods include, for example, a coating system; a liquid spray system; a spray system via a gas phase such as a system which ejects liquid droplets employing vibration of a piezoelectric element, e.g., a piezo-system ink-jet head; a BUBBLE JET (a registered trademark) ink-jet head which ejects liquid droplets employing a thermal head utilizing bumping; and a spray system which sprays liquid via air or liquid pressure.

Any coating system may appropriately be selected from the coating systems known in the art, and examples thereof include an air doctor coater, a blade coater, a rod coater, a knife coater, a squeeze coater, an impregnation coater, a reverse roller coater, a transfer roller coater, a curtain coater, a double roller coater, a slide hopper coater, a gravure coater, a kiss roll coater, a bead coater, a cast coater, a spray coater, a calender coater, and an extrusion coater.

Drying of an aqueous mixture of an aqueous compound and a white pigment provided on a medium may be carried out using any method provided that water can be evaporated by the method. Examples include heating via a heat source, a heating method using infrared radiation, and a heating method using electromagnetic induction. Further, water evaporation may be carried out under reduced pressure.

The term “being porous” referred to in the present invention refers to a penetration state able to induce dissolution and deposition reaction of silver and to allow ion species to migrate between electrodes as described below: a porous white scattering material is formed by coating an aqueous mixture of the aqueous compound and the white pigment on an electrode, followed by drying the aqueous mixture; an electrolyte liquid, containing silver or a compound containing silver in its chemical structure, is applied on the scattering material, and then sandwiched by the opposed electrodes; and an electrical potential difference is applied between the opposed electrodes.

In the display element of the present invention, an aqueous compound is desirably hardened with a hardener during coating and drying or after drying of the aqueous mixture described above.

Examples of such a hardener used in the present invention include the hardeners described in official gazettes, including, for example, U.S. Pat. No. 4,678,739 specification, column 41, U.S. Pat. No. 4,791,042 specification, JP-A Nos. 59-116655, 62-245261, 61-18942, 61-249054, 61-245153, and 4-218044.

More specifically, there are listed aldehyde based hardeners (e.g., formaldehyde), aziridine based hardeners, epoxy based hardeners, vinyl sulfone based hardeners (e.g., N,N′-ethylene-bis(vinylsulfonylacetamido)ethane), N-methylol based hardeners (e.g., dimethylol urea), boric acid, metaboric acid, and polymer hardeners (compounds described, for example, in JP-A No. 62-234157). When gelatin is used as an aqueous compound, of such hardeners, vinyl sulfone based hardeners and chlorotriazine based hardeners are preferably used individually or in combination. Further, when polyvinyl alcohol is used, boron-containing compounds such as boric acid or metaboric acid are preferably used.

Any of these hardeners is used in the range of 0.001-1 g per gram of an aqueous compound, more preferably 0.005-0.5 g. Further, to enhance film hardness, thermal treatment or humidity adjustment during hardening reaction can be carried out.

In the present invention, any of the following compounds may be added in addition to the above electrolyte solvent and the supporting electrolyte.

(Silver Salt Solvents)

In the display element of the present invention, in order for an electrolyte to accelerate dissolution and deposition of a metal salt (especially, a silver salt), at least 1 type of compound represented by following Formula (G1) or Formula (G2) is preferably contained.

Compounds represented by Formula (G1) and Formula (G2) are ones accelerating solubilization of silver in an electrolyte to induce dissolution and deposition of the silver in the present invention. Generally, to allow silver to be dissolved and deposited, the silver needs to be solubilized in an electrolyte. For example, useful is a compound containing a chemical structure species exhibiting interaction with silver to produce a coordination bond or a loose covalent bond to the silver.

As the chemical structure species, a halogen atom, a mercapto group, a carboxyl group, and an imino group are known. In the present invention, compounds containing a thioether group and mercaptoazoles effectively act as silver solvents, also exhibiting high solubility to solvents with minimal adverse effects to coexistent compounds.

Rg₁₁-S-Rg₁₂ Formula (G1)

wherein Rg₁₁ and Rg₁₂ each represents a substituted or unsubstituted hydrocarbon group. Further, such a hydrocarbon group may contain at least one atom selected from a nitrogen atom, an oxygen atom, a phosphor atom, a sulfur atom, and a halogen atom. Rg₁₁ and Rg₁₂ each may join to form a cyclic structure. Substitutable groups for the hydrocarbon group include, for example, an amino group, a guanidino group, a quaternary ammonium group, a hydroxyl group, a halogen compound, a carboxylic acid group, a carboxylate group, an amide group, a sulfinic acid group, a sulfonic acid group, a sulfate group, a phosphonic acid group, a phosphate group, a nitro group, and a cyano group.

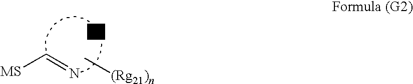

wherein M represents a hydrogen atom, a metal atom, or a quaternary ammonium; Z represents an atomic group needed to constitute a nitrogen-containing heterocyclic ring; n represents an integer of 0-5; and Rg₂₁ represents a substituent and when n is 2 or more, Rg₂₁'s each may be the same or differ or may join to form a condensed ring.

Specific examples of the compound represented by Formula (G1) according to the present invention will now be listed but the present invention is not limited only to these exemplified compounds.

### G1-1: CH₃SCH₂CH₂OH

### G1-2: HOCH₂CH₂SCH₂CH₂OH

### G1-3: HOCH₂CH₂SCH₂CH₂SCH₂CH₂OH

### G1-4: HOCH₂CH₂SCH₂CH₂SCH₂CH₂SCH₂CH₂OH

G1-5: HOCH₂CH₂SCH₂CH₂OCH₂CH₂OCH₂CH₂SCH₂CH₂CH₂OH
G1-6: HOCH₂CH₂OCH₂CH₂SCH₂CH₂SCH₂CH₂OCH₂CH₂OH

### G1-7: H₃CSCH₂CH₂COOH

### G1-8: HOOCCH₂SCH₂COOH

### G1-9: HOOCCH₂CH₂SCH₂CH₂COOH

### G1-10: HOOCCH₂SCH₂CH₂SCH₂COOH

### G1-11: HOOCCH₂SCH₂CH₂SCH₂CH₂SCH₂CH₂SCH₂COOH

G1-12 HOOCCH₂CH₂SCH₂CH₂SCH₂CH(OH) CH₂SCH₂CH₂SCH₂CH₂COOH
G1-13: HOOCCH₂CH₂SCH₂CH₂SCH₂CH(OH)CH(OH)CH₂SCH₂CH₂SCH₂CH₂COOH

### G1-14: H₃CSCH₂CH₂CH₂NH₂

### G1-15: H₂NCH₂CH₂SCH₂CH₂NH₂

### G1-16: H₂NCH₂CH₂SCH₂CH₂SCH₂CH₂NH₂

### G1-17: H₃CSCH₂CH₂CH(NH₂)COOH

G1-18: H₂NCH₂CH₂OCH₂CH₂SCH₂CH₂SCH₂CH₂OCH₂CH₂NH₂
G1-19: H₂NCH₂CH₂SCH₂CH₂OCH₂CH₂OCH₂CH₂SCH₂CH₂NH₂
G1-20H₂NCH₂CH₂SCH₂CH₂SCH₂CH₂SCH₂CH₂SCH₂CH₂NH₂

### G1-21: HOOC(NH₂)CHCH₂CH₂SCH₂CH₂SCH₂CH₂CH(NH₂)COOH

G1-22: HOOC(NH₂)CHCH₂SCH₂CH₂OCH₂CH₂OCH₂CH₂SCH₂CH(NH₂)COOH
G1-23: HOOC(NH₂)CHCH₂OCH₂CH₂SCH₂CH₂SCH₂CH₂OCH₂CH(NH₂)COOH
G1-24: H₂N(═O)CCH₂SCH₂CH₂OCH₂CH₂OCH₂CH₂SCH₂C(═O)NH₂

### G1-25: H₂N(O═)CCH₂SCH₂CH₂SCH₂C(O═)NH₂

### G1-26: H₂NHN(O═)CCH₂SCH₂CH₂SCH₂C(═O)NHNH₂

### G1-27: H₃C(O═)NHCH₂CH₂SCH₂CH₂SCH₂CH₂NHC(O═) CH₃

G1-28: H₂NO₂SCH₂CH₂SCH₂CH₂SCH₂CH₂SO₂NH₂
G1-29: NaO₃SCH₂CH₂CH₂SCH₂CH₂SCH₂CH₂CH₂SO₃Na
G1-30: H₃CSO₂NHCH₂CH₂SCH₂CH₂SCH₂CH₂NHO₂SCH₃

### G1-31: H₂N(NH)CSCH₂CH₂SC(NH)NH₂.2HBr

### G1-32: H₂(NH)CSCH₂CH₂OCH₂CH₂OCH₂CH₂SC(NH)NH₂.2HCl

### G1-33: H₂N(NH)CNHCH₂CH₂SCH₂CH₂SCH₂CH₂NHC(NH)NH₂.2HBr

### G1-34 [(CH₃)₃NCH₂CH₂SCH₂CH₂SCH₂CH₂N(CH₃)₃]²⁺.2Cl⁻

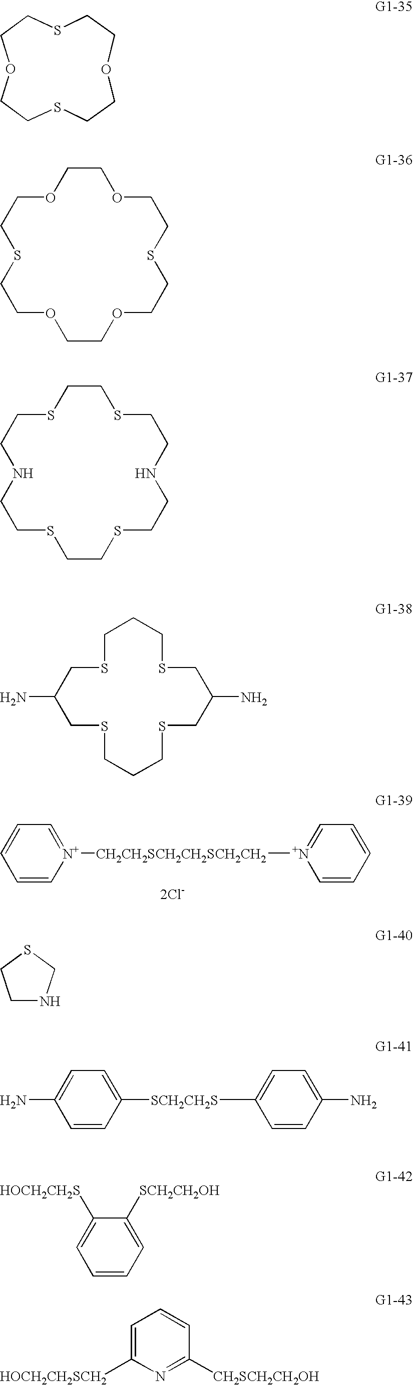

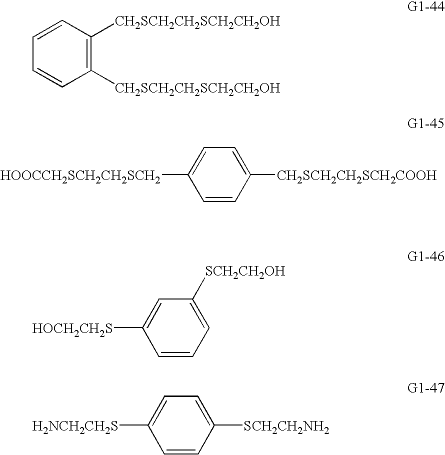

Of the above exemplified compounds, exemplified compound G1-2 is specifically preferable from the viewpoint of sufficiently producing the targeted effects of the present invention.

Next, the compound represented by Formula (G2) according to the present invention is described below.

In above Formula (G2), M represents a hydrogen atom, a metal atom, or a quaternary ammonium; Z represents a nitrogen-containing heterocyclic ring except imidazole rings; n represents an integer of 0-5; and Rg₂₁ represents a hydrogen atom, a halogen atom, an alkyl group, an aryl group, an alkylcarbonamide group, an arylcarbonamide group, an alkylsulfonamide group, an arylsulfonamide group, an alkoxy group, an aryloxy group, an alkylthio group, an arylthio group, an alkylcarbamoyl group, an arylcarbamoyl group, a carbamoyl group, an alkylsulfamoyl group, an arylsulfamoyl group, a sulfamoyl group, a cyano group, an alkylsulfonyl group, an arylsulfonyl group, an alkoxycarbonyl group, an aryloxycarbonyl group, an alkylcarbonyl group, an arylcarbonyl group, an acyloxy group, a carboxyl group, a carbonyl group, a sulfonyl group, an amino group, an hydroxy group, or a heterocyclic group, and when n is 2 or more, Rg₂₁'s each may be the same or differ or may join to form a condensed ring.

The metal atom represented by M of Formula (G2) includes, for example, Li, Na, K, Mg, Ca, Zn, and Ag. A quaternary ammonium includes NH₄, N(CH₃)₄, N(C₄H₉)₄, N(CH₃)₃C₁₂H₂₅, N(CH₃)₃C₁₆H₃₃, and N(CH₃)₃CH₂C₆H₅.

The nitrogen-containing heterocyclic ring represented by Z of Formula (G2) includes, for example, a tetrazole ring, a triazole ring, an imidazole ring, an oxydiazole ring, a thiadiazole ring, an indole ring, an oxazole ring, a benzoxazole ring, a benzimidazole ring, a benzothiazole ring, a benzoselenazole ring, and a naphthoxazole ring.

The halogen atom represented by Rg₂₁ of Formula (G2) includes a fluorine atom, a chlorine atom, a bromine atom, and an iodine atom; the alkyl group includes, for example, a methyl group, an ethyl group, a propyl group, an i-propyl group, a butyl group, a t-butyl group, a pentyl group, a cyclopentyl group, a hexyl group, a cyclohexyl group, an octyl group, a dodecyl group, a hydroxyethyl group, a methoxyethyl group, a trifluoromethyl group, and a benzyl group; the aryl group includes, for example, a phenyl group, and a naphthyl group; the alkylcarbonamide group includes, for example, an acetylamino group, a propionylamino, and a butyroylamino group; the arylcarbonamide group includes, for example, an benzoylamino group; the alkylsulfonamide group includes, for example, a methanesulfonylamino group and an ethanesulfonylamino group; the arylsulfonamide group includes, for example, a benzenesulfonylamino group and a toluenesulfonylamino group; the aryloxy group includes, for example, a phenoxy group; the alkylthio group includes, for example, a methylthio group, an ethylthio group, and a butylthio group; the arylthio group includes, for example, a phenylthio group and a tolylthio group; the alkylcarbamoyl group includes, for example, a methylcarbamoyl group, a dimethylcarbamoyl group, an ethylcarbamoyl group, a diethylcarbamoyl group, a dibutylcarbamoyl group, a piperidylcarbamoyl group, and a morpholylcarbamoyl group; the arylcarbamoyl group includes, for example, a phenylcarbamoyl group, a methylphenylcarbamoyl group, an ethylphenylcarbamoyl group, and a benzylphenylcarbamoyl group; the alkylsulfamoyl group includes, for example, a methylsulfamoyl group, a dimethylsulfamoyl group, an ethylsulfamoyl group, a diethylsulfamoyl group, a dibutylsulfamoyl group, a piperidylsulfamoyl group, and a morpholylsulfamoyl group; the arylsulfamoyl group includes, for example, a phenylsulfamoyl group, a methylphenylsulfamoyl group, an ethylphenylsulfamoyl group, and a benzylphenylsulfamoyl group; the alkylsulfonyl group includes, for example, a methanesulfonyl group and an ethanesulfonyl group; the arylsulfonyl group includes, for example, a phenylsulfonyl group, a 4-chlorophenylsulfonyl group, and a p-toluenesulfonyl group; the alkoxycarbonyl group includes, for example, a methoxycarbonyl group, an ethoxycarbonyl group, and a butoxycarbonyl group; the aryloxycarbonyl group includes, for example, a phenoxy carbonyl group; the alkylcarbonyl group includes, for example, an acetyl group, a propionyl group, and a butyroyl group; the arylcarbonyl group includes, for example, a benzoyl group and an alkylbenzoyl group; the acyloxy group includes, for example, an acetyloxy group, a propionyloxy group, and a butyroyloxy group; and the heterocyclic ring group includes, for example, an oxazole ring, a thiazole ring, a triazole ring, a selenazole ring, a tetrasol ring, an oxadiazole ring, a thiadiazole ring, a thiazine ring, a triazine ring, a benzoxazole ring, a benzothiazole ring, an indolenine ring, a benzoselenazole ring, a naphthothiazole ring, a triazaindolizine ring, a diazaindolizine ring, and a tetraazaindolizine ring. These substituents may further have a substituent.

Next, preferable specific examples of the compound represented by Formula (G2) will now be listed but the present invention is not limited thereto.

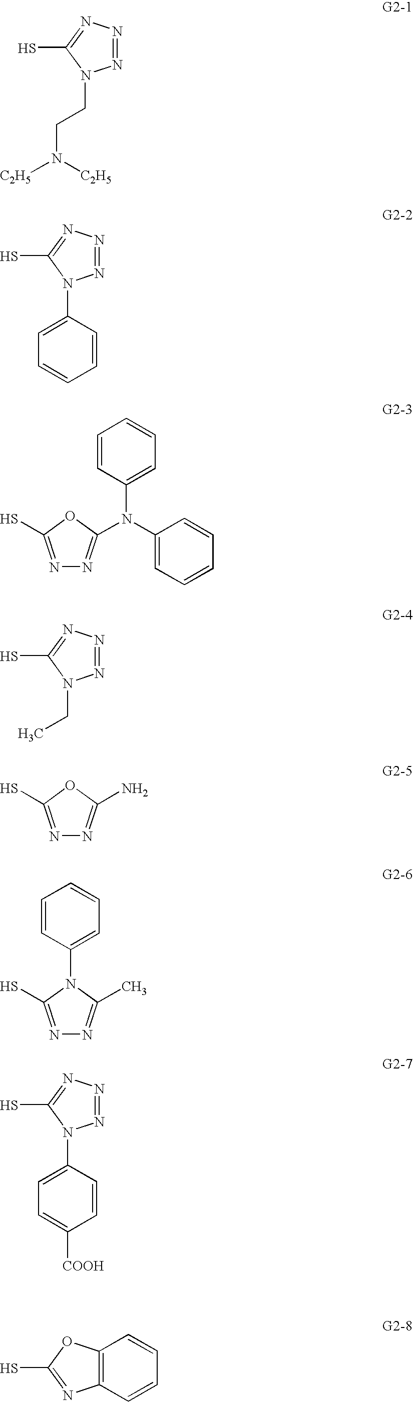

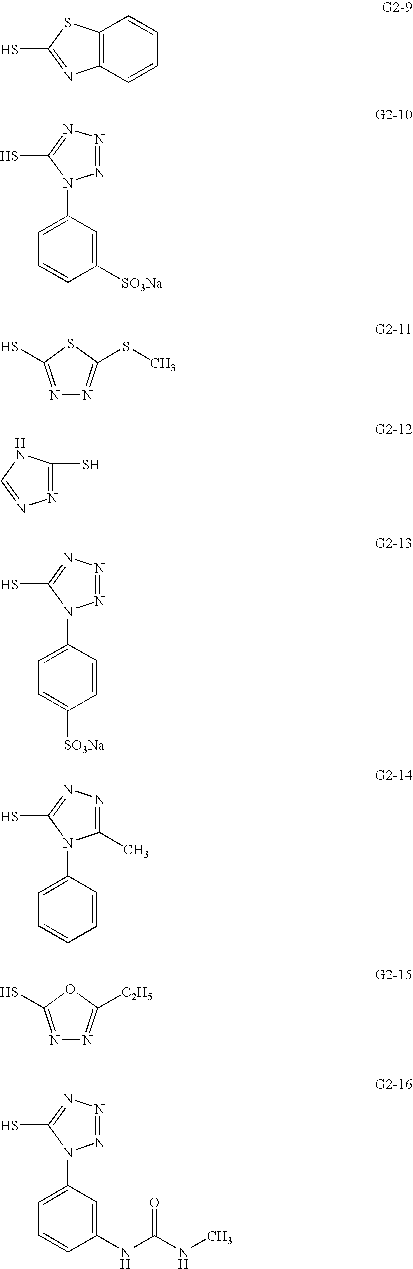

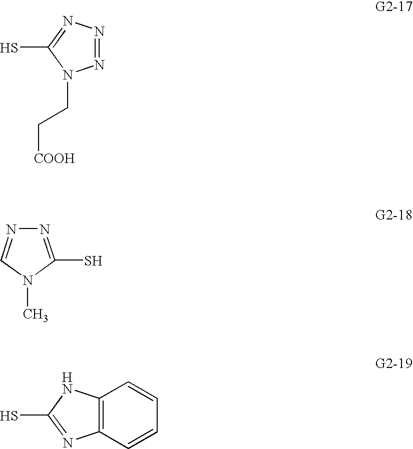

Of the above exemplified compounds, exemplified compounds G2-12 and G2-18 are specifically preferable from the viewpoint of sufficiently producing the targeted effects of the present invention.

(Electron Insulation Layer)

In the display element of the present invention, an electron insulation layer can be arranged.

The electron insulation layer applicable to the present invention is only required to be a layer which exhibits ion conductivity as well as electron insulation properties. Examples thereof include a solid electrolyte film in which a polymer having a polar group or a salt is formed into a film, a quasi-solid electrolyte film having a porous film with high electron insulation properties and an electrolyte in its voids, a polymer porous film having voids, and a porous body made of an inorganic material exhibiting low dielectric constant such as a silicon-containing compound.

As a formation method of a porous film, there can be used any of the well-known formation methods such as a firing method (a fusion method) (polymer fine particles or inorganic particles are added to a binder and partially fused, and then pores having been generated among particles are utilized), an extraction method (a constituent layer is formed of an organic or inorganic substance soluble in a solvent and a binder insoluble in the solvent, and then the organic or inorganic substance is dissolved with the solvent to obtain fine pores), a foaming method in which a polymer is allowed to foam by heating or degassing, a phase conversion method in which a mixture of polymers is phase-separated via manipulation of a good solvent and a poor solvent, or a radiation irradiation method to form fine pores via irradiation of various kinds of radiations.

Specifically, there are listed electron insulation layers described in official gazettes such as JP-A Nos. 10-30181 and 2003-107626, Examined Japanese Patent Application Publication No. 7-95403, and Japanese Patent Publication Nos. 2635715, 2849523, 2987474, 3066426, 3464513, 3483644, 3535942, and 3062203.

(Thickeners Added to an Electrolytic Liquid)

In the display element of the present invention, a thickener can be used for an electrolytic liquid. Examples thereof include gelatin, gum arabic, poly(vinyl alcohol), hydroxyethyl cellulose, hydroxypropyl cellulose, cellulose acetate, cellulose acetate butyrate, poly(vinylpyrrolidone), poly(alkylene glycol), casein, starch, poly(acrylic acid), poly(methylmethacrylic acid), poly(vinyl chloride), poly(methacrylic acid), copoly(styrene-maleic anhydride), copoly(styrene-acrylonitrile), copoly(styrene-butadiene), poly(vinyl acetals) (e.g., poly(vinyl formal) and poly(vinyl butyral)), poly(esters), poly(urethanes), phenoxy resins, poly(vinylidene chloride), poly(epoxides), poly(carbonates), poly(vinyl acetate), cellulose esters, and poly(amides), as well as, as hydrophobic transparent binders, polyvinyl butyral, cellulose acetate, cellulose acetate butyrate, polyester, polycarbonate, polyacrylic acid, and polyurethane.

These thickeners may be used in combinations of at least 2 kinds. Further, there can be listed the compounds described on pages 71-75 of JP-A No. 64-13546. Of these, preferably used compounds are polyvinyl alcohols, polyvinyl pyrrolidones, hydroxypropyl celluloses, polyalkylene glycols, and polyvinyl acetals from the viewpoint of compatibility with various additives and enhancement of dispersion stability of white particles.

(Other Additives)

As constituent layers of the display element of the present invention, auxiliary layers such as a protective layer, a filter layer, an antihalation layer, a cross-over light cutting layer, and a backing layer can be listed. In these auxiliary layers, there can be contained, as appropriate, various types of chemical sensitizers, noble metal sensitizers, photosensitive dyes, supersensitizers, couplers, high-boiling point solvents, antifoggants, stabilizers, development inhibitors, bleaching accelerators, fixing accelerators, color mixing inhibitors, formalin scavengers, toning agents, hardeners, surfactants, thickeners, plasticizers, lubricants, UV absorbents, anti-irradiation dyes, filter light-absorbing dyes, fungicides, polymer latexes, heavy metals, antistatic agents, and matting agents.

These additives described above are further detailed in articles of Research Disclosure (hereinafter referred to as RD), Volume 176, Item/17643 (December 1978); RD, Volume 184, Item/18431 (August 1979); RD, Volume 187, Item/18716 (November 1979); and RD, Volume 308, Item/308119 (December 1989).

Types and described portions of the compounds cited in these three articles of Research Disclosure are listed below.

| | Additive | | | | | |
|---|---|---|---|---|---|---|
| | RD 17643 | | RD 18716 | | RD 308119 | |
| | | Classi- | | Classi- | | Classi- |
| | Page | fication | Page | fication | Page | fication |
| Chemical | 23 | III | 648 | upper | 96 | III |
| Sensitizer | | | | right | | |
| Sensitizing | 23 | IV | 648-649 | | 996-8 | IV |
| Dye | | | | | | |
| Desensitizing | 23 | IV | | | 998 | IV |
| Dye | | | | | | |
| Dye | 25-6 | VIII | 649-650 | | 1003 | VIII |
| Development | 29 | XXI | 648 | upper | | |
| Accelerator | | | | right | | |
| Antifoggant, | 24 | IV | 649 | upper | 1006-7 | VI |
| Stabilizer | | | | right | | |
| Bleaching | 24 | V | | | 998 | V |
| Agent | | | | | | |
| Hardener | 26 | X | 651 | left | 1004-5 | X |
| Surfactant | 26-7 | XI | 650 | right | 1005-6 | XI |
| Antistatic | 27 | XII | 650 | right | 1006-7 | XIII |
| Agent | | | | | | |
| Plasticizer | 27 | XII | 650 | right | 1006 | XII |
| Lubricant | 27 | XII | | | | |
| Matting Agent | 28 | XVI | 650 | right | 1008-9 | XVI |
| Binder | 26 | XXII | | | 1003-4 | IX |
| Support | 28 | XVII | | | 1009 | XVI |

(Substrate)

As substrates used in the present invention, there are also preferably usable synthetic plastic films including polyolefins such as polyethylene or polypropylene, polycarbonates, cellulose acetate, polyethylene terephthalate, polyethylene dinaphthalene carboxylate, polyethylene naphthalates, polyvinyl chloride, polyimides, polyvinyl acetals, and polystyrene. Polystyrenes having a syndiotactic structure are also preferable.

These substances can be obtained via any of the methods described, for example, in JP-A Nos. 62-117708, 1-46912, and 1-178505. Further, there are exemplified metallic substrates such as stainless steel, paper supports such as baryta paper or resin-coated paper, supports prepared by forming a reflection layer on a plastic film as described above, and those described as supports in JP-A No. 62-253195 (pages 29-31). Also, there are preferably used those described on page 28 of RD No. 17643, in the right column of page 647—left column of page 648 of RD No. 18716, and on page 879 of RD, No. 307105.

As any of these supports, usable are those with a minimized core-set curl tendency realized via thermal treatment at a temperature of at most Tg as described in U.S. Pat. No. 4,141,735. Further, the surface of any of these supports may be surface-treated to enhance adhesion between the support and other constituent layers. In the present invention, glow discharge treatment, UV irradiation treatment, corona treatment, and flame treatment can be employed for such surface treatment.

Further, the supports described on pages 44-149 of Kochi Gijutsu (Known Techniques), No. 5 (issued on Mar. 22, 1991, published by Aztech Corp.) can be used. Still further, there are exemplified those described on page 1009 of RD, No. 308119 and in the section of “Supports” of Product Licensing Index, Vol. 92, page 108. In addition, glass substrates, and glass-incorporated epoxy resins are employable.

In the display element of the present invention, sealing agents, columnar structure materials, and spacer particles can be used, if appropriate.

Sealing agents, functioning to perform sealing so as for any leakage not to occur, are also referred to as sealants. There are employable curable type resins including thermally curable, light curable, moisture curable, or anaerobically curable type resins such as epoxy resins, urethane resins, acrylic resins, vinyl acetate reins, ene-thiol resins, silicon resins, or modified polymer resins.

Columnar structure materials provide strong self-holding properties (strength) between substrates, including, for example, columnar structure materials such as cylindrical, square pole, elliptically cylindrical, and trapezoidally cylindrical bodies which are arranged so as to form a predetermined pattern such as a grid arrangement at regular intervals. Those arranged in a stripe arrangement manner at predetermined intervals are also usable. The columnar structure material is not arranged at random, but preferably arranged so as to appropriately hold the distance of substrates and not to inhibit image display, for example, via arrangement at regular intervals, via arrangement in which the intervals are gradually varied, or via arrangement in which a predetermined arrangement pattern is repeated at a constant frequency. When the ratio of the area of a columnar structure material to the display area of a display element is 1-40%, the columnar structure material realizes practically adequate strength as the display element.

A spacer may be provided between paired substrates to maintain a uniform gap between them. As such a spacer, spheres composed of resins or inorganic oxides can be exemplified. Further, adhesion spacers, whose surface is coated with thermoplastic resins, are suitably used. A columnar structure material may be provided alone to maintain a uniform gap between the substrates. However, both a spacer and a columnar structure material may also be provided. Instead of such a columnar structure material, only a spacer may be employed as a space-maintaining member. The diameter of such a spacer, when a columnar structure material is formed, is at most its height, but is preferably equal to the height. When no columnar material is formed, the diameter of the spacer corresponds to the thickness of a cell gap.

(Display Element Driving Method)

A controlling method of a transparent state and a colored state of the display element of the present invention is preferably determined based on the redox potential of an electrochromic compound contained. For example, when a metal salt compound and a compound represented by Formula (1) are contained as electrochromic compounds, such determination is preferably made based on the redox potential of the compound represented by Formula (1) and the deposition overvoltage of the metal salt compound.

For example, when a display element has a compound represented by Formula (1) and a silver salt compound between the opposed electrodes, a colored state other than black is expressed on the oxidation side and a black state is expressed on the reduction side. As one example of a controlling method in this case, there is exemplified a method in which a voltage higher than the redox potential of a compound represented by Formula (1) is applied and then the compound represented by Formula (1) is oxidized to express a colored state other than black; a voltage somewhere between the redox potential of the compound represented by Formula (1) and the deposition overvoltage of a silver salt compound is applied and then the compound represented by Formula (1) is reduced to return to a white state; a voltage lower than the deposition overvoltage of the silver salt compound is applied and then silver is deposited on the electrode to express a black state; and a voltage somewhere between the oxidation potential of the deposited silver and the redox potential of the compound represented by Formula (1) is applied and then the deposited silver is dissolved for decoloration.

A driving operation of the display element of the present invention may be a simple matrix drive or active matrix drive. The simple matrix drive referred to in the present invention refers to a driving method in which electrical current is sequentially applied to a circuit formed by vertically crossing of a positive line containing plural positive electrodes to a facing negative line containing plural negative electrodes. The use of such a simple matrix drive has the advantage that the circuit structure and the driving IC are capable of being simplified to reduce the production cost. The active matrix drive refers to a driving method using TFT circuits in which scanning lines, data lines, and current supplying lines are formed in a grid manner and the TFT circuits are positioned in each of the grids. The active matrix drive is advantageous in gradation and memory functions since a switching function can be allocated to each pixel. The circuit described, for example, in FIG. 5 of JP-A 2004-29327 is employable.

(Commercial Product Applications)

The display element of the present invention is applied to fields including electronically published books, ID cards, public use, transportation, broadcasting, financial clearance, and distribution and logistics. Specific examples include door keys, student ID cards, employee ID cards, various membership cards, convenience store cards, department store cards, vending machine cards, gas station cards, subway and railroad cards, bus cards, cashing cards, credit cards, highway cards, driver's license cards, hospital consultation cards, electronic medical charts, health insurance cards, basic resident registers, passports, and electronic books.

### EXAMPLES

The present invention will now specifically be described with reference to examples that by no means limit the scope of the present invention. Incidentally, “parts” or “%” referred to in the examples represents “parts by mass” or “% by mass”, unless otherwise specified.

### Example 1

### Production of Electrodes

(Production of Electrode 1)

An ITO (Indium Thin Oxide) film of a pitch of 145 μm and an electrode width of 130 μm was formed on a glass substrate having a thickness of 1.5 mm and a size of 2 cm×4 cm by a well-known method to obtain a display electrode (electrode 1).

(Production of Electrode 2)

An ITO paste (produced by Sumitomo Metal Mining Co., Ltd.) of an average particle diameter of 20 nm was further blade-coated on electrode 1, followed by firing at 60° C. for 2 minutes and at 450° C. for 30 minutes to obtain a porous ITO electrode (electrode 2).

(Production of Electrode 3)

A nickel electrode having an electrode thickness of 0.1 μm, a pitch of 145 μm, and an electrode distance of 130 μm was formed on a glass substrate of a thickness of 1.5 mm and a size of 2 cm×4 cm by a well-known method. The thus-obtained electrode was further immersed in a displacement gold plating bath to obtain a gold-nickel electrode (electrode 3) in which gold displacement was carried out at a depth of 0.05 μm from the electrode surface.

(Production of Electrode 4)

Ink liquid 1 to be described later was applied on electrode 2 at 120 dpi (“dpi” refers to the number of dots per inch or 2.54 cm) using an ink-jet apparatus having a piezo-system head to produce electrode 4.

(Production of Electrode 5)

Ink liquid 2 to be described later was applied on electrode 3 at 120 dpi using the ink-jet apparatus having a piezo-system head to produce electrode 5.

(Production of Electrode 6)

Ink liquid 3 to be described later was applied on electrode 2 at 120 dpi using the ink-jet apparatus having a piezo-system head to produce electrode 6.

(Production of Electrode 7)

Electrode 7 was obtained in the same manner as in production of electrode 6 except that ink liquid 3 was replaced with ink liquid 4.

<<Preparation of Ink Liquids>>

(Preparation of Ink Liquid 1)

Exemplified compound (1)-12 was dissolved in acetonitrile/ethanol at 3 mmol/l to prepare ink liquid 1.

(Preparation of Ink Liquid 2)

Exemplified compound (1)-56 was dissolved in tetrahydrofuran so that the content of the mother nucleus portion represented by Formula (1) was 3 mmol/l to prepare ink liquid 2.

(Preparation of Ink Liquid 3)

Exemplified compound (1)-50 was dissolved in acetonitrile/ethanol at 3 mmol/l to prepare ink liquid 3.

(Preparation of Ink Liquid 4)

Exemplified compound (1)-60 was dissolved in tetrahydrofuran so that the content of the mother nucleus portion represented by Formula (1) was 3 mmol/l to prepare ink liquid 4.

<<Preparation of Electrolytic Liquids>>

(Preparation of Electrolytic Liquid 1)

Dissolved were 0.1 g of bismuth chloride, 0.1 g of lithium bromide, and 0.025 g of tetrabutyl ammonium perchlorate in 2.5 g of dimethyl sulfoxide to obtain electrolytic liquid 1.

(Preparation of Electrolytic Liquid 2)

Dissolved were 0.1 g of silver p-toluenesulfonate and 0.025 g of tetrabutyl ammonium perchlorate in 2.5 g of dimethyl sulfoxide to obtain electrolytic liquid 2.

(Preparation of Electrolytic Liquid 3)

Dissolved were 0.1 g of silver p-toluenesulfonate, 0.2 g of 4H-1,2,4-triazole-3-thiol, and 0.025 g of spiro-(1,1′)-bipyrrolidinium tetrafluoroborate in 2.5 of γ-butylolactone to obtain electrolytic liquid 3.

<<Production of Display Elements>>

(Production of Display Element 1-1)

A mixed liquid, prepared by adding 20% by mass of titanium dioxide CR-90 (produced by Ishihara Sangyo Kaisha, Ltd.) in an isopropanol solution containing polyvinyl alcohol (average polymerization degree: 3500 and saponification degree: 87%) at 2% by mass, followed by being dispersed using an ultrasonic homogenizer, was coated on electrode 3 whose peripheral portion was edged with an olefin sealant containing a glass-made spherical bead spacer of an average particle diameter of 40 μm at a volume fraction of 10% to allow film thickness after drying to be 20 μm. Thereafter, drying was carried out at 15° C. for 30 minutes to evaporate the solvent and then further drying was carried out under an ambience of 45° C. for 1 hour.

A glass-made spherical bead spacer of an average particle diameter of 20 μm was spread on the thus-obtained titanium dioxide layer and then electrode 3 and electrode 1 were bonded together, followed by being thermally pressed to produce an empty cell. Electrolytic liquid 3 was vacuum-injected into the empty cell and the inlet was sealed with a UV curable epoxy resin to produce display element 1.

(Production of Display Elements 1-2-6)

Display elements 1-2-1-6 were obtained in the same manner as in production of display element 1-1 except that electrode 3 was replaced with electrodes 2 and 4-7, respectively.

(Production of Display Elements 1-7 and 8)

Display elements 1-7 and 8 were obtained in the same manner as in production of above display element 1-5 except that electrolytic liquid 3 was replaced with electrolytic liquid 1 and 2, respectively.

<<Evaluation of the Display Elements>>

[Evaluation of Reflectance Stability During Repetitive Driving]

Each of the both electrodes of a produced display element was connected to each of the corresponding terminals of a constant-voltage power supply and a voltage of +1.5 V was applied for 1.5 seconds, followed by application of a voltage of −1.5 V for 1 second. Then, reflectance at a wavelength of 550 nm during gray display was determined using spectrophotometer CM-3700d (produced by Konica Minolta Sensing, Inc.). Driving was carried out 10 times in total under the same driving conditions and then the average value of the obtained reflectances was designated as Rₐᵥₑ₁. Further, repetitive driving was carried out 10000 times to determine R_{Rave2} in the same manner. R_{BK1} was designated as the indicator of reflectance stability when repetitive driving was carried out employing the relationship of R_{BK1}=|Rₐᵥₑ₁−Rₐᵥₑ₂|. Herein, when the value of R_{BK1} is smaller, reflectance stability during repetitive driving becomes superior. The thus-obtained evaluation results of the display elements each are shown in Table 1.

TABLE 1

| | | Electrode Constitution | | | Evaluation | |
|---|---|---|---|---|---|---|
| Display | Electrolytic | Display | Opposed | Formula (1) | Result | |
| Element | Liquid No. | Electrode No. | Electrode No. | Compound No. | ΔR_{BK1} (%) | Remarks |
| 1-1 | 3 | 1 | 3 | — | 30 | Comparative |
| 1-2 | 3 | 1 | 2 | — | 32 | Comparative |
| 1-3 | 3 | 1 | 4 | (1)-12 | 23 | Inventive |
| 1-4 | 3 | 1 | 5 | (1)-56 | 26 | Inventive |
| 1-5 | 3 | 1 | 6 | (1)-50 | 17 | Inventive |
| 1-6 | 3 | 1 | 7 | (1)-60 | 16 | Inventive |
| 1-7 | 1 | 1 | 6 | (1)-50 | 25 | Inventive |
| 1-8 | 2 | 1 | 6 | (1)-50 | 20 | Inventive |

The results described in Table 1 clearly show that the display elements satisfying the constitution of the present invention exhibit improved reflectance stability during repetitive driving, compared to the comparative examples.

### Example 2

The electrodes, ink liquids, and electrolytic liquids obtained in Example 1 were also used in Example 2 in the same manner.

<<Production of Electrodes>>

(Production of Electrode 8)

A titanium dioxide (4-10 particles of an average particle diameter of 17 nm had been subjected to necking) layer was formed on electrode 1 described in Example 1 and further ink liquid 5 to be described later was applied on the electrode at 120 dpi using an ink-jet apparatus having a piezo head to produce electrode 8.

(Production of Electrodes 9-11)

Electrodes 9-11 were obtained in the same manner as for electrode 8 except that ink liquid 5 was replaced with following ink liquids 6-8, respectively.

<<Preparation of Ink Liquids>>

(Preparation of Ink Liquid 5)

Electrochromic compound EC-1 [bis-(2-phosphonoethyl)-4,4′-bipyridium dibromide] was dissolved in acetonitrile/ethanol at 3 mmol/l to prepare ink liquid 5.

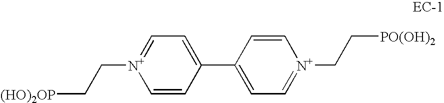

(Preparation of Ink Liquid 6)

Exemplified compound (1)-26 was dissolved in acetonitrile/ethanol at 3 mmol/l to prepare ink liquid 6.

(Preparation of Ink Liquid 7)

Exemplified compound (1)-29 was dissolved in acetonitrile/ethanol at 3 mmol/l to prepare ink liquid 7.

(Preparation of Ink Liquid 8)

Exemplified compound (1)-50 was dissolved in acetonitrile/ethanol at 3 mmol/l to prepare ink liquid 8.

<<Preparation of Electrolytic Liquids>>

(Preparation of Electrolytic Liquid 4)

Dissolved was 0.025 g of tetrabutyl ammonium perchlorate in 2.5 g of dimethyl sulfoxide to obtain electrolytic liquid 4.

(Preparation of Electrolytic Liquid 5)

Dissolved was 0.025 g of spiro-(1,1′)-bipyrrolidinium tetrafluoroborate in 2.5 of γ-butylolactone to obtain electrolytic liquid 5.

<<Production of Display Elements>>

(Production of Display Element 2-1)

A mixed liquid, prepared by adding 20% by mass of titanium dioxide CR-90 (produced by Ishihara Sangyo Kaisha, Ltd.) in an isopropanol solution containing polyvinyl alcohol (average polymerization degree: 3500 and saponification degree: 87%) at 2% by mass, followed by being dispersed using an ultrasonic homogenizer, was coated on electrode 3, described in Example 1, whose peripheral portion was edged with an olefin sealant containing a glass-made spherical bead spacer of an average particle diameter of 40 μm at a volume fraction of 10% to allow film thickness after drying to be 20 μm. Thereafter, drying was carried out at 15° C. for 30 minutes to evaporate the solvent and then further drying was carried out under an ambience of 45° C. for 1 hour.

A glass-made spherical bead spacer of an average particle diameter of 20 μm was spread on the thus-obtained titanium dioxide layer and then electrode 3 and electrode 8 were bonded together, followed by being thermally pressed to produce an empty cell. Electrolytic liquid 4 was vacuum-injected into the empty cell and the inlet was sealed with a UV curable epoxy resin to produce display element 2-1.

(Production of Display Elements 2-2-5)

Display elements 2-2-5 were obtained in the same manner as in production of display element 2-1 except that electrode 3 was replaced with one of electrodes 4-7, respectively.

(Production of Display Element 2-6)

Display element 2-6 was obtained in the same manner as in production of display element 2-4 except that electrode 8 was replaced with electrode 9.

(Production of Display Element 2-7)

Display element 2-7 was obtained in the same manner as in production of display element 2-6 except that electrolytic liquid 4 and electrode 6 were replaced with electrolytic liquid 5 and electrode 3, respectively.

(Production of Display Element 2-8)

Display element 2-8 was obtained in the same manner as in production of display element 2-7 except that electrode 3 was replaced with electrode 6.

(Production of Display Elements 2-9 and 10)

Display element 2-9 and 10 were obtained in the same manner as in production of display element 2-7 except that electrode 9 was replaced with electrodes 10 and 11, and electrode 3 was replaced with electrode 6.

<<Evaluation 1: Evaluation of Display Elements 2-1-5>>

[Evaluation of Reflectance Stability During Repetitive Driving]

Each of the both electrodes of a produced display element was connected to each of the corresponding terminals of a constant-voltage power supply and a voltage of +1.5 V was applied for 1.5 seconds, followed by application of a voltage of −1.5 V for 1 second. Then, reflectance at the maximum absorption wavelength in the visible range during colored display was determined using spectrophotometer CM-3700d (produced by Konica Minolta Sensing, Inc.). Driving was carried out 10 times in total under the same driving conditions and then the average value of the obtained reflectances was designated as Rₐᵥₑ₃. Further, repetitive driving was carried out 10000 times to determine Rₐᵥₑ₄ in the same manner. R_{COLOR2} was designated as the indicator of reflectance stability when repetitive driving was carried out employing the relationship of R_{COLCOR2}=|Rₐᵥₑ₃−Rₐᵥₑ₄|. Herein, when the value of R_{COCLOR2} is smaller, reflectance stability during repetitive driving becomes superior.

<<Evaluation 2: Evaluation of Display Elements 2-6-10>>

[Evaluation of Reflectance Stability During Repetitive Driving]

Display elements 2-6-10 were evaluated in the same manner as in Evaluation 1 described above except that a voltage of −1.5 V was applied for 1.5 seconds, followed by application of a voltage of +1.5 V for 1 second to realize colored display.

The thus-obtained evaluation results of the display elements each are shown in Table 2.

TABLE 2

| | | | Electrode Constitution | | | Evaluation | |
|---|---|---|---|---|---|---|---|
| Display | Electrochromic | Electrolytic | Display | Opposed | Formula (1) | Result | |
| Element | Compound | Liquid No. | Electrode No. | Electrode No. | Compound No. | ΔR_{COLOR2} (%) | Remarks |
| 2-1 | EC-1 | 4 | 8 | 3 | — | 31 | Comparative |
| 2-2 | EC-1 | 4 | 8 | 4 | (1)-12 | 23 | Inventive |
| 2-3 | EC-1 | 4 | 8 | 5 | (1)-56 | 25 | Inventive |
| 2-4 | EC-1 | 4 | 8 | 6 | (1)-50 | 18 | Inventive |
| 2-5 | EC-1 | 4 | 8 | 7 | (1)-60 | 16 | Inventive |
| 2-6 | (1)-26 | 4 | 9 | 6 | (1)-50 | 17 | Inventive |
| 2-7 | (1)-26 | 5 | 9 | 3 | — | 28 | Comparative |
| 2-8 | (1)-26 | 5 | 9 | 6 | (1)-50 | 16 | Inventive |
| 2-9 | (1)-29 | 5 | 10 | 6 | (1)-50 | 15 | Inventive |
| 2-10 | (1)-50 | 5 | 11 | 6 | (1)-50 | 9 | Inventive |

The results described in Table 2 clearly show that the display elements satisfying the constitution of the present invention exhibit improved reflectance stability during repetitive driving, compared to the comparative examples.

### Example 3

The electrodes, inks, and electrolytic liquids obtained in Examples 1 and 2 were also used in Example 3 in the same manner.

<<Production of Display Elements>>

(Production of Display Element 3-1)

A mixed liquid, prepared by adding 20% by mass of titanium dioxide CR-90 (produced by Ishihara Sangyo Kaisha, Ltd.) in an isopropanol solution containing polyvinyl alcohol (average polymerization degree: 3500 and saponification degree: 87%) at 2% by mass, followed by being dispersed using an ultrasonic homogenizer, was coated on electrode 3 whose peripheral portion was edged with an olefin sealant containing a glass-made spherical bead spacer of an average particle diameter of 40 μm at a volume fraction of 10% to allow film thickness after drying to be 20 μm. Thereafter, drying was carried out at 15° C. for 30 minutes to evaporate the solvent and then further drying was carried out under an ambience of 45° C. for 1 hour.

A glass-made spherical bead spacer of an average particle diameter of 20 μm was spread on the thus-obtained titanium dioxide layer and then electrode 3 and electrode 11 were bonded together, followed by being thermally pressed to produce an empty cell. Electrolytic liquid 3 was vacuum-injected into the empty cell and the inlet was sealed with a UV curable epoxy resin to produce display element 3-1.

(Production of Display Elements 3-2-5)

Display elements 3-2-5 were obtained in the same manner as in production of above display element 3-1 except that electrode 3 was replaced with electrodes 4-7, respectively.

<<Evaluation of the Display Elements>>

[Evaluation of Reflectance Stability During Repetitive Driving]

Each of the both electrodes of a produced display element was connected to each of the corresponding terminals of a constant-voltage power supply. Then, reflectances at a wavelength of 550 nm during gray display via application of a voltage of −1.5 V for 1.5 seconds and at the maximum absorption wavelength in the visible range during colored display via application of a voltage of +1.5 V for 1.5 seconds were determined using spectrophotometer CM-3700d (produced by Konica Minolta Sensing, Inc.). Driving was carried out 10 times in total under the same driving conditions. Then, the average values of the obtained gray reflectances and of the reflectances in the colored state were separately calculated, being each designated as Rₐᵥₑ₅ and Rₐᵥₑ₆. Further, repetitive driving was carried out 10000 times to determine Rₐᵥₑ₇ and Rₐᵥₑ₈ in the same manner. R_{BK3} and R_{COLOR3} were designated as the indicators of reflectance stability when repetitive driving was carried out employing the relationship of R_{BK3}=|Rₐᵥₑ₅−Rₐᵥₑ₇| and R_{COLCOR3}=|Rₐᵥₑ₆−Rₐᵥₑ₈|. Herein, when the values of R_{BK3} and R_{COCLOR3} are smaller, reflectance stability during repetitive driving becomes superior.

The thus-obtained evaluation results of the display elements each are shown in Table 3.

TABLE 3

| | | | Electrode Constitution | | | | | |
|---|---|---|---|---|---|---|---|---|
| Display | Electrochromic | Electrolytic | Display | Opposed | Formula (1) | Evaluation Result | | |
| Element | Compound | Liquid No. | Electrode No. | Electrode No. | Compound No. | ΔR_{BK1}(%) | ΔR_{COLOR2}(%) | Remarks |
| 3-1 | Silver | 3 | 11 | 3 | — | 28 | 32 | Comparative |
| | tosylate + (1)-50 | | | | | | | |
| 3-2 | Silver | 3 | 11 | 4 | (1)-12 | 24 | 26 | Inventive |
| | tosylate + (1)-50 | | | | | | | |
| 3-3 | Silver | 3 | 11 | 5 | (1)-56 | 18 | 27 | Inventive |
| | tosylate + (1)-50 | | | | | | | |
| 3-4 | Silver | 3 | 11 | 6 | (1)-50 | 17 | 20 | Inventive |
| | tosylate + (1)-50 | | | | | | | |
| 3-5 | Silver | 3 | 11 | 7 | (1)-60 | 20 | 21 | Inventive |
| | tosylate + (1)-50 | | | | | | | |

The results described in Table 3 clearly show that the display elements satisfying the constitution of the present invention exhibit improved reflectance stability during repetitive driving, compared to the comparative example.

What is claimed is:

1. A display element containing at least 1 type of electrochromic compound, which is reversibly subjected to coloration or decoloration by at least either of electrochromic oxidation and reduction reaction, and an electrolyte between a pair of a display electrode and an opposed electrode; and undergoing a color tone change by an electrode driving operation, wherein a compound represented by following Formula (1) is held on the opposed electrode. 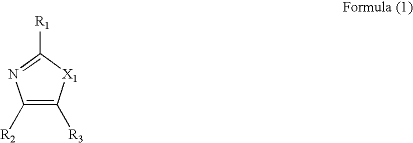
wherein R₁ represents a substituent; R₂ and R₃ each represent a hydrogen atom or a substituent; X₁ represents —N(R₄)—, —S—, or —O—; and R₄ represents a hydrogen atom or a substituent.

2. The display element of claim 1, wherein a compound represented by Formula (1) is chemically bonded to an opposed electrode via a silyl group.

3. The display element of claim 1, wherein a white scattering material is contained between a pair of the display electrode and the opposed electrode and substantial white display and colored display other than white are carried out by an electrode driving operation.

4. The display element of claim 1, wherein a metal salt compound, which can be dissolved and deposited by an electrode driving operation, is contained as an electrochromic compound in the electrolyte and black display and white display are carried out by the electrode driving operation.

5. The display element of claim 4, wherein the metal salt compound is a silver salt compound.

6. The display element of claim 1, wherein a compound represented by Formula (1) is contained as the electrochromic compound.

7. The display element of claim 6, wherein an electrochromic compound represented by Formula (1) is chemically bonded to the display electrode surface via a silyl group.

8. The display element of claim 1, wherein a promoter is contained in the electrolyte.

9. The display element of claim 8, wherein the promoter is an N-oxyl derivative, an N-hydroxyphthalimide derivative, a hydroxamic acid derivative, or a metallocene derivative.

10. The display element of claim 1, wherein the opposed electrode is a porous metal oxide electrode.

11. The display element of claim 10, wherein the porous metal oxide electrode is formed of a metal oxide fine particle.

12. The display element of claim 11, wherein the metal oxide fine particle is composed of ITO or titanium oxide.

13. The display element of claim 1, wherein the electrolyte contains at least 1 type of compound represented by following Formula (G1) or Formula (G2).
Rg₁₁-S-Rg₁₂ Formula (G1)
wherein Rg₁₁ and Rg₁₂ each represent a substituted or unsubstituted hydrocarbon group; the hydrocarbon group may contain at least one atom selected from a nitrogen atom, an oxygen atom, a phosphor atom, a sulfur atom, and a halogen atom; and Rg₁₁ and Rg₁₂ each may join to form a ring structure. 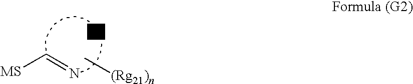
wherein M represents a hydrogen atom, a metal atom, or a quaternary ammonium; Z represents an atomic group needed to constitute a nitrogen-containing heterocyclic ring; n represents an integer of 0-5; and Rg₂₁ represents a substituent and when n is 2 or more, Rg₂₁'s each may be the same or differ or may join to form a condensed ring.
